(19) United States
(12) Patent Application Publication
(10) Pub. No.: US 2021/0363794 A1
(43) Pub. Date: Nov. 25, 2021

(54) DOOR HANDLE ASSEMBLY FOR A VEHICLE DOOR

(71) Applicant: HUF HÜELSBECK & FÜERST GMBH & CO. KG, Velbert (DE)

(72) Inventors: Michael Rhein, Moenchengladbach (DE); Bernd Reifenberg, Essen (DE); Jan Heyduck, Sindelfingen (DE); Juergen Jooss, Boeblingen (DE); Martin Lindmayer, Sulz (DE)

(73) Assignee: Huf Huelsbeck & Fuerst GmbH & Co. KG, Velbert (DE)

(21) Appl. No.: 16/479,819

(22) PCT Filed: Dec. 6, 2017
(86) PCT No.: PCT/EP2017/081650

§ 371 Date: Jul. 22, 2019

(30) Foreign Application Priority Data
Jan. 25, 2017 (DE) 10 2017 101 419.5

(51) Int. Cl. E05B 85/10

(52) U.S. Cl. CPC E05B 85/107; E05B 85/103

(57) ABSTRACT

A door handle assembly for a vehicle door includes a handle which is mounted on a handle housing, a lever element, a motor-driven actuating element which rotates the lever element during normal operation of the door handle assembly and moves the handle out of the non-use position into an actuated position, and a lever mechanism. During an emergency operation, in the event of a malfunction of the actuating element, the handle is movable into an emergency handling position in which a first longitudinal end of the handle is moved towards the handle housing and a second longitudinal end of the handle is moved away from the handle housing. The lever mechanism includes a holding element which allows a movement of the first longitudinal end of the handle relative to a second end of the lever element and a movement of the second longitudinal end of the handle away from the handle housing.

The invention relates to a door handle assembly for a vehicle door, wherein the door handle assembly has a handle for actuation by an operator, which extends strake-flush with an outer contour of the vehicle door in a non-use position, and a handle housing which can be fastened to the vehicle door, wherein the handle is mounted on the handle housing via a lever element.

Door handle assemblies in which the handle in its non-use position extends strake-flush with the outer contour of the vehicle door are known from the prior art. Thereby, the handle may be designed as an inner or outer handle in the case of these types of door handle assemblies for a vehicle door of a motor vehicle, wherein the present invention relates to a door handle assembly for an outer handle. For such door handle assemblies, there is a plurality of different constructions and embodiments. The design according to the invention of a door handle assembly relates to constructions in which the handle housing is fastened to the rear side of the vehicle door, i.e. the inside of the vehicle. The handle, which is fastened to the handle housing, usually protrudes from the vehicle door in such embodiments and disturbs both the aesthetic impression of the vehicle and its aerodynamics. In order to avoid these disadvantages, there are known prior art door handle assemblies in which the outside of the handle in its non-use position, i.e. in which it is not used, extends approximately flush with the outer contour of the vehicle door, i.e. strake-flush. Such a handle can be transferred to an actuated position for opening the vehicle door or an on-board lock, in which the handle protrudes relative to the outer contour of the vehicle door. The handle is moved out using a motor when a legitimate operator approaches the vehicle. Once the handle is no longer needed, it returns to the non-use position and disappears into the vehicle body to avoid producing air resistance. A disadvantage of the known door handle assemblies is that if the motor drive malfunctions, the handle can no longer be moved out from the outer contour of the vehicle and opening a door is almost impossible, which is quite problematic due to safety-related reasons.

The invention is based on the object of creating a solution which provides a structurally simple door handle assembly which is cost-effective to manufacture and in which the handle can be moved out from the outer contour of the vehicle and actuated for opening the door even in the case of a malfunction of the motor drive.

This object is achieved according to the invention by a door handle assembly for a vehicle door with the features according to claim 1.

The door handle assembly for a vehicle door according to the invention comprises a handle housing, which can be fastened to the vehicle door, a handle which is mounted on the handle housing and which extends strake-flush with an outer contour of the vehicle door in a non-use position and which is movably formed for actuation by an operator into an actuated position, in which the handle protrudes relative to the outer contour of the vehicle door, a lever element, wherein a first lever end is rotatably attached to a lever rotational axis mounted on the handle housing and wherein a second lever end is movably coupled to a first longitudinal end of the handle, a motor-driven actuating element which in normal operation of the door handle assembly rotates the lever element around the lever rotational axis and thereby moves the handle from the non-use position into the actuated position, and a lever mechanism which movably mounts a second longitudinal end of the handle on the handle housing. The first longitudinal end of the handle is rotatably mounted on the second lever end of the lever element. Further, in an emergency operation of the door handle assembly in the case of a malfunction of the motor-driven actuating element, the handle is movable by the operator into an emergency handling position in which, with respect to the non-use position, the first longitudinal end of the handle moves towards the handle housing and the second longitudinal end of the handle is arranged to move away from the handle housing. Thereby, the lever mechanism has a holding element which allows a movement of the first longitudinal end of the handle towards the handle housing and relative to the second lever end of the lever element and a movement of the second longitudinal end of the handle away from the handle housing against a holding force exerted by the holding element.

Advantageous and practical embodiments and further developments of the invention result from the subclaims.

The invention provides a door handle assembly for a vehicle, which is characterized by a functional construction and has a compact and cost-effective installation. In the door handle assembly according to the invention, the compression force manually exerted by an operator of the door handle assembly on the first longitudinal end of the handle causes the handle to be urged towards the handle housing at its first longitudinal end, whereby, however, the second longitudinal end of the handle emerges from the outer contour of the vehicle and can be grasped by the operator to transfer the handle to its actuated position, from where it is then possible to actuate the handle by the operator to open the on-board lock. Therefore, with the door handle assembly according to the invention, it is possible to open the vehicle door purely manually on malfunction of the electrical supply. This ensures that the door handle assembly is fully functional even in an emergency, such as an electroless emergency operation, while still maintaining maximum aerodynamic advantages in normal operation.

The lever mechanism according to the invention is intended to expose the handle from the non-use position with its second longitudinal end out of the outer contour of the vehicle door during emergency operation. Thereby the invention is designed in such a way that the lever mechanism has a passive lever, an active lever coupled to the motor-driven actuating element and a handle lever, wherein a first end of the first passive lever and a first end of the active lever are mounted on a rotational axis mounted on the handle housing, wherein a first end of the handle lever is rotatably connected to the second longitudinal end of the handle and a second end of the handle lever is rotatably connected to a second end of the passive lever. The mounting of the passive lever and the active lever on the rotational axis permits a very compact construction form of the door handle assembly, which occupies little installation space.

In order to provide the desired functionality in the case of an emergency operation and to be able to move the handle with its second longitudinal end out of the outer contour of the vehicle door, according to an embodiment the invention provides that the first end of the passive lever is connected to the rotational axis in a torque-proof manner and the first end of the active lever is connected to the rotational axis in a rotatable manner.

In an embodiment of the invention it is further provided that the passive lever has an abutment portion, and a counter abutment portion is formed on the active lever, wherein in the non-use position of the handle the holding element presses the abutment portion of the passive lever with respect to the counter abutment portion of the active lever. This position is occupied by the passive lever and the active lever during normal operation of the door handle assembly when the handle is arranged in its non-use position and when the handle is moved from the non-use position to its actuated position.

However, in an emergency operation, the invention provides that in the emergency handling position of the handle, a compression force exerted by an operator and exceeding the holding force of the holding element acts on the first longitudinal end of the handle and the abutment section of the passive lever is arranged to be rotated away from the counter abutment section of the active lever. In this way, it is possible for the operator to move the second longitudinal end of the handle out of the outer contour and grasp it by pressing the first longitudinal end inwardly, in order to actuate the handle manually.

Regarding an emergency operation of the door handle assembly, the invention provides in an additional embodiment in which during a movement from the non-use position into the emergency handling position, the handle transmits a compression force exerted at the first longitudinal end by the operator via the second longitudinal end to the passive lever of the lever mechanism and effects a relative rotation of the passive lever with respect to the active lever, with the result that in the emergency handling position the abutment portion of the passive lever is arranged spaced apart from the counter abutment portion. The relative rotation occurs thereby around the stationary rotational axis arranged on the handle housing.

In order for the handle to be held in its location during normal operation, it is provided in an additional embodiment of the invention that the holding force of the holding element is dimensioned so that the holding element presses the abutment portion of the passive lever against the counter abutment portion of the active lever up to an acceleration force acting in the case of a vehicle accident or up to a compression force of at least 30 g exerted by the operator. In this way, in normal operation, the handle is held crash-protected in its location at an acceleration force of up to 30 g, whereby during emergency operation this force must be overcome in order to move the handle from the non-use position into the emergency handling position.

A particularly simple and cost-effective option provided by the invention is that the holding element is formed as an elastic spring element, wherein a first leg of the spring element engages in a hook-shaped holding lug formed on the passive lever and a second leg of the spring element engages in a hook-shaped holding lug formed on the active lever.

The invention further provides for a compact formation of the door handle assembly that the spring element is wound around the rotational axis.

In order for the handle not to be able to be pressed indefinitely in the direction of the handle housing at its first longitudinal end and to avoid the danger of a damage of the handle housing, the embodiment of the invention provides that the lever element between its first lever end and its second lever end has a supporting lug which, in the emergency handling position, abuts on a movement limiting lug formed on the handle and limiting the movement of the handle in the direction of the handle housing.

It should be understood that the features mentioned above and those still to be explained below may be used not only in the combination indicated but also in other combinations or in a unique position, without leaving the scope of the present invention. The scope of the invention is defined only by the claims.

Further details, features, and advantages of the subject-matter of the invention result from the following description in connection with the drawing, in which exemplary and preferred exemplary embodiments of the invention are presented. In which:

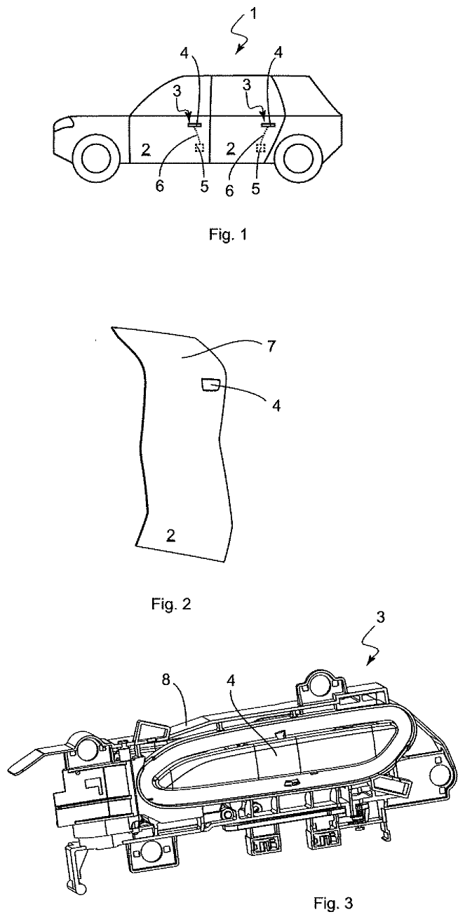

FIG. 1 shows a schematically represented motor vehicle with an exemplarily suggested door handle assembly according to the invention,

FIG. 2 shows a perspective representation of a vehicle door with a handle, which is arranged strake-flush with the door handle assembly according to the invention,

FIG. 3 shows a perspective front view of the door handle assembly according to the invention,

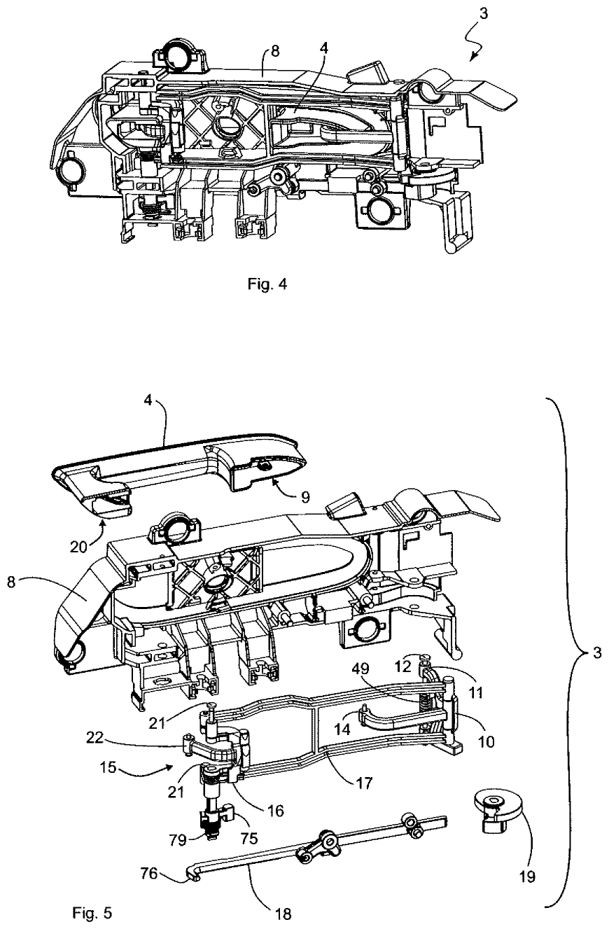

FIG. 4 shows a perspective rear view of the door handle assembly shown in FIG. 3,

FIG. 5 shows a perspective representation of the individual parts of the door handle assembly shown in FIGS. 3 and 4,

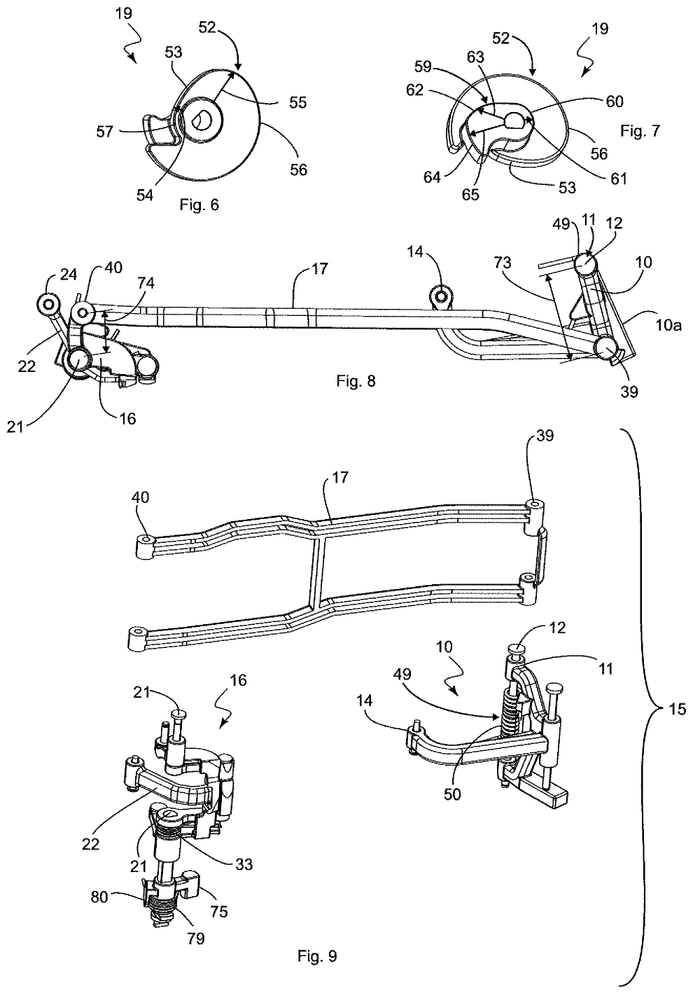

FIG. 6 shows a top view of an actuating element of the door handle assembly,

FIG. 7 shows a bottom view of the actuating element of the door handle assembly shown in FIG. 6,

FIG. 8 shows a top view of a lever system of the door handle assembly,

FIG. 9 shows a perspective representation of the individual parts of the lever system shown in FIG. 8,

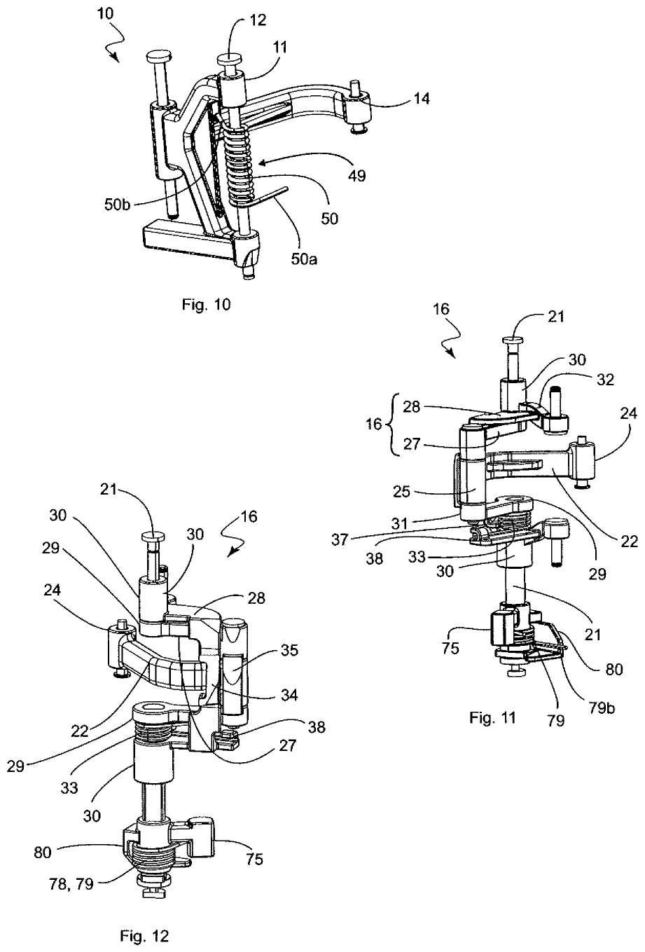

FIG. 10 shows a perspective view of a lever element of the lever system shown in FIG. 8,

FIG. 11 shows a first perspective view of a lever mechanism of the lever system shown in FIG. 8,

FIG. 12 shows a second perspective view of the lever mechanism shown in FIG. 11,

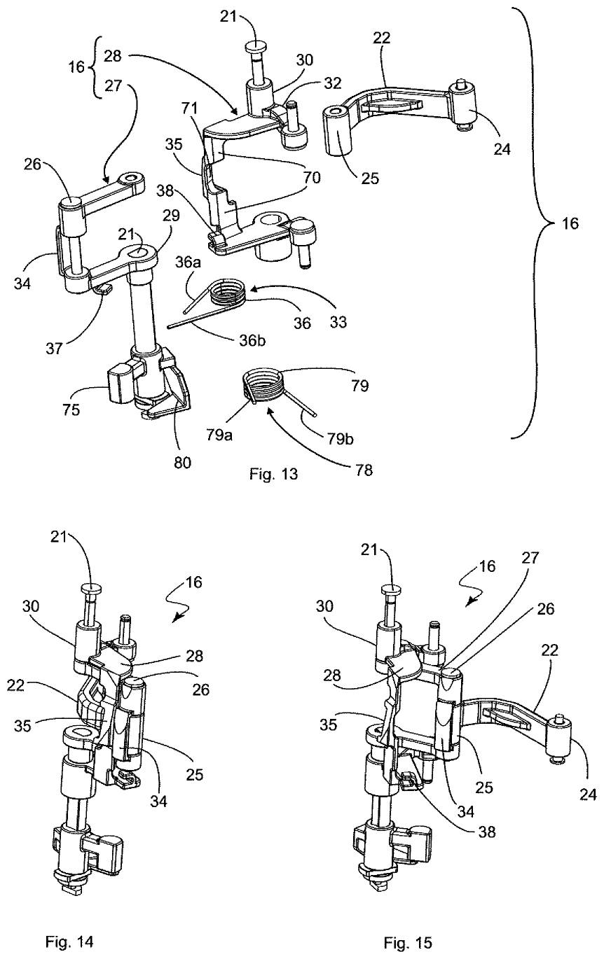

FIG. 13 shows a perspective representation of the individual parts of the lever mechanism shown in FIGS. 11 and 12,

FIG. 14 shows a perspective view of the lever mechanism arranged in a basic position shown in FIG. 11,

FIG. 15 shows a perspective view of the lever mechanism arranged in an operating position shown in FIG. 11,

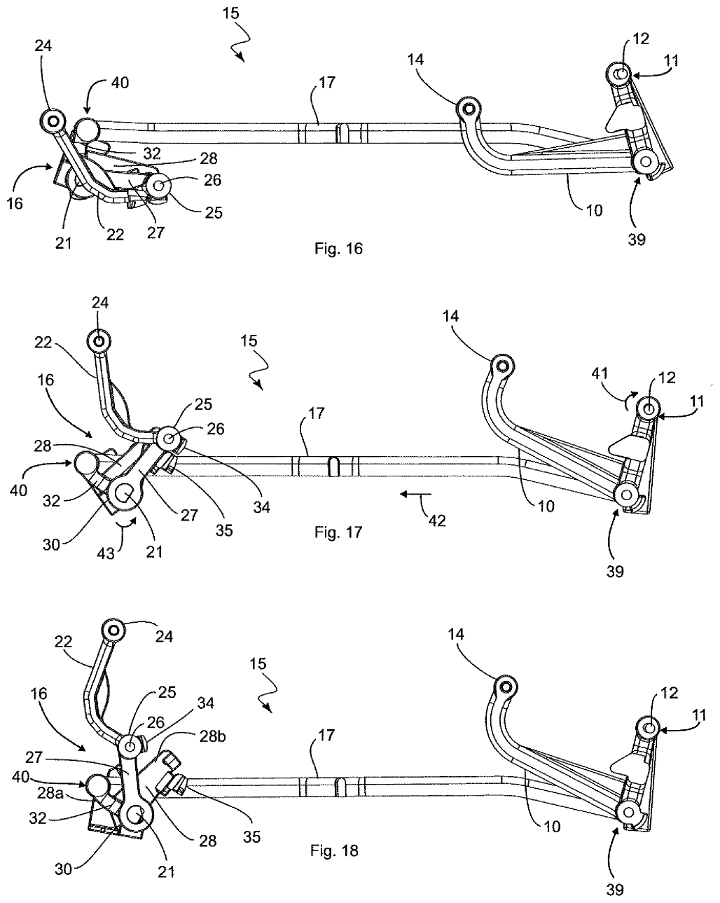

FIG. 16 shows a top view of the lever system of the door handle assembly when the handle is arranged in a non-use position,

FIG. 17 shows a top view of the lever system of the door handle assembly when the handle is arranged in an actuated position,

FIG. 18 shows a top view of the lever system of the door handle assembly when an operator pulls the handle in order to open the vehicle door,

FIG. 19a shows a top view of the lever element shown in FIG. 10 when the handle is arranged in the non-use position,

FIG. 19b shows a top view of the lever element when the handle is arranged in the actuated position,

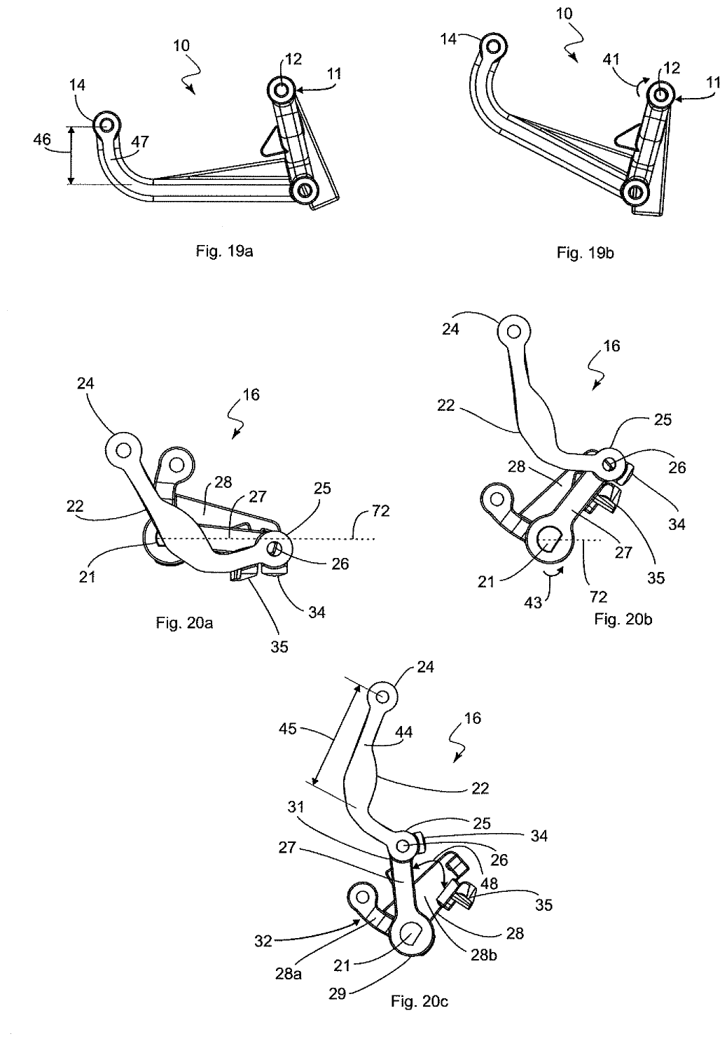

FIG. 20a shows a top view of the lever mechanism shown in FIG. 11 when the handle is arranged in the non-use position,

FIG. 20b shows a top view of the lever mechanism when the handle is arranged in the actuated position,

FIG. 20c shows a top view of the lever mechanism when an operator pulls the handle in order to open the vehicle door,

FIG. 21 shows a side view of the door handle assembly according to the invention when the handle is arranged in the non-use position,

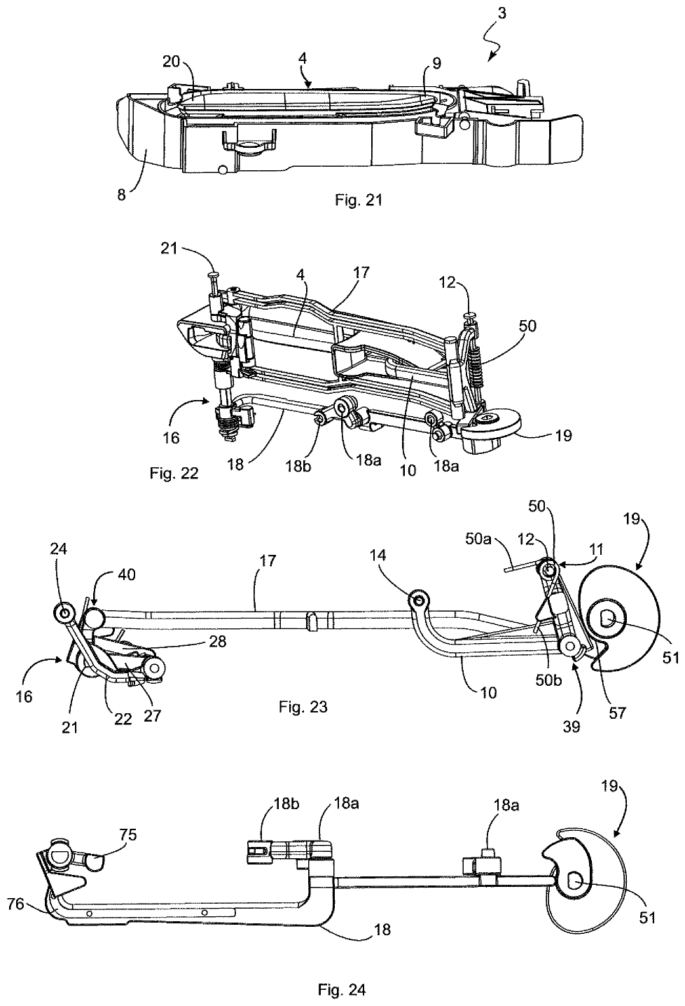

FIG. 22 shows a perspective view of the lever system and a vehicle door opening lever when the handle is arranged in the non-use position,

FIG. 23 shows a top view of the lever system when the handle is arranged in the non-use position,

FIG. 24 shows a bottom view of the lever system when the handle is arranged in the non-use position,

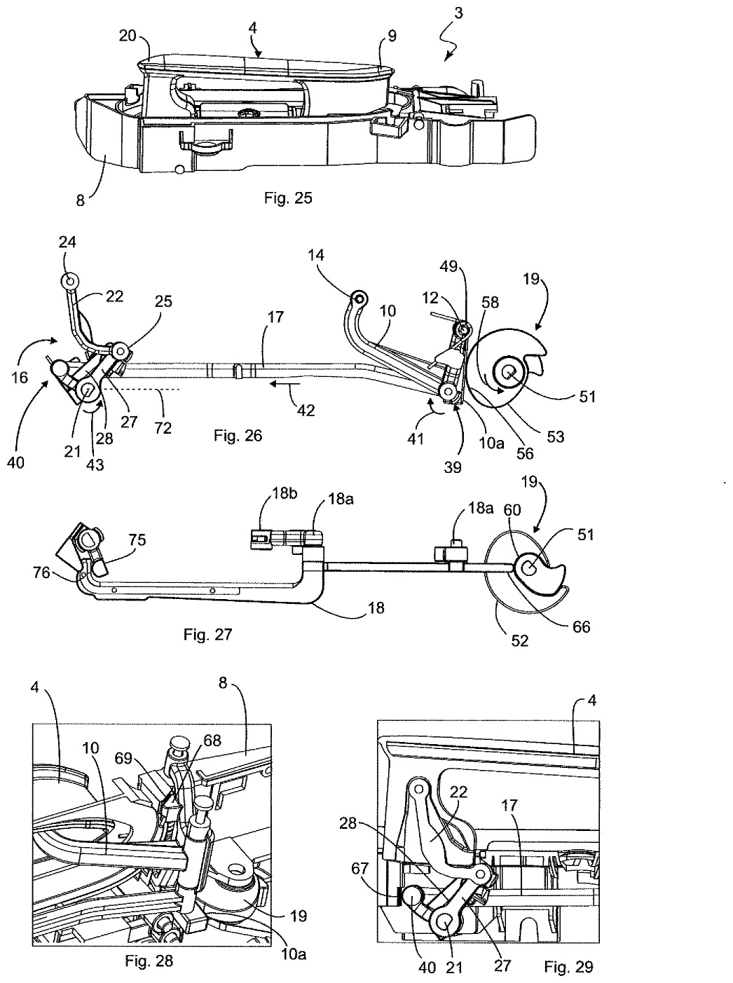

FIG. 25 shows a side view of the door handle assembly according to the invention when the handle is arranged in the actuated position,

FIG. 26 shows a top view of the lever system when the handle is arranged in the actuated position,

FIG. 27 shows a bottom view of the lever system when the handle is arranged in the actuated position,

FIG. 28 shows a detailed view of the lever element when the handle is arranged in the actuated position,

FIG. 29 shows a detailed view of the lever mechanism when the handle is arranged in the actuated position,

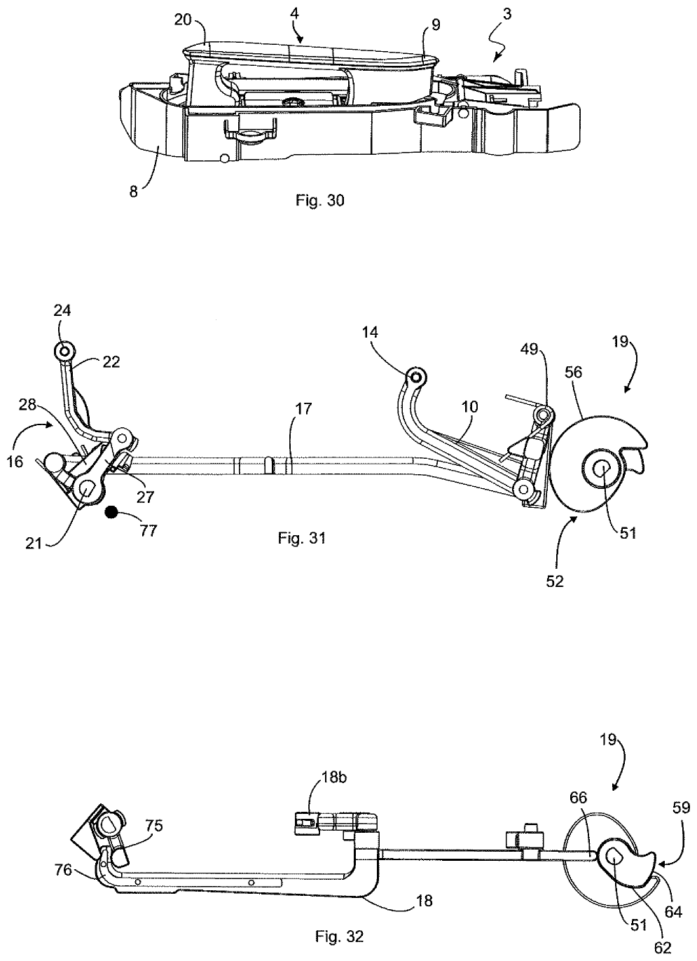

FIG. 30 shows a side view of the door handle assembly according to the invention when the handle is arranged in a servo-opening position,

FIG. 31 shows a top view of the lever system when the handle is arranged in the servo-opening position,

FIG. 32 shows a bottom view of the lever system when the handle is arranged in the servo-opening position,

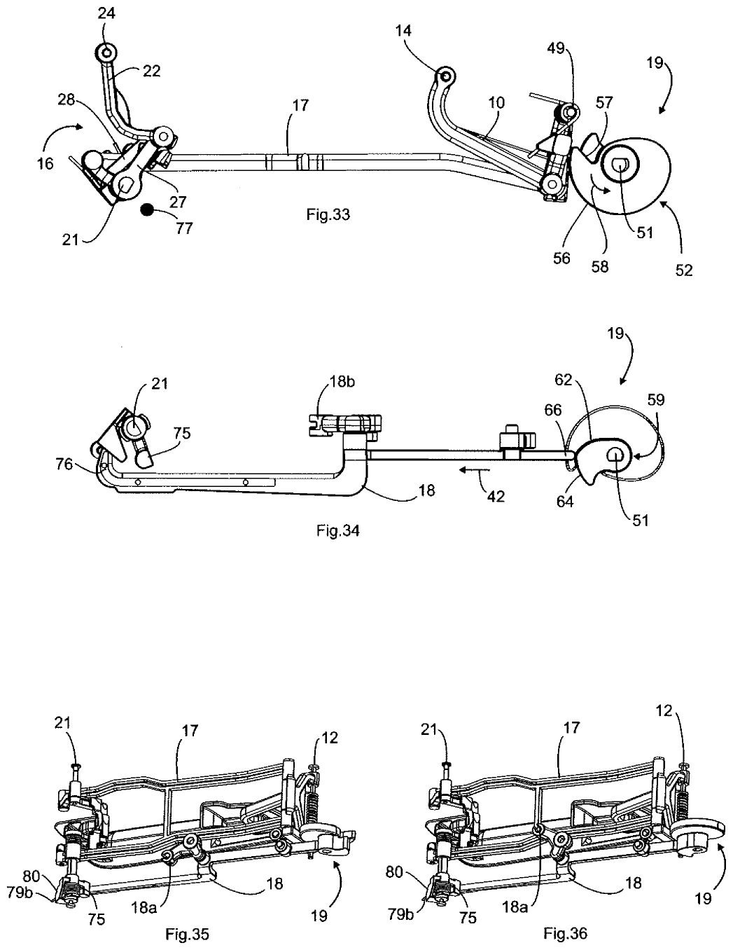

FIG. 33 shows a top view of the lever system when the actuating element is arranged and moved due to the location of the handle in the servo-opening position,

FIG. 34 shows a bottom view of the lever system when the actuating element is arranged and moved due to the positioning of the handle in the servo-opening position,

FIG. 35 shows a perspective side view of the lever system when the handle is arranged in the servo-opening position,

FIG. 36 shows a perspective side view of the lever system when the actuating element is arranged and moved due to the location of the handle in the servo-opening position,

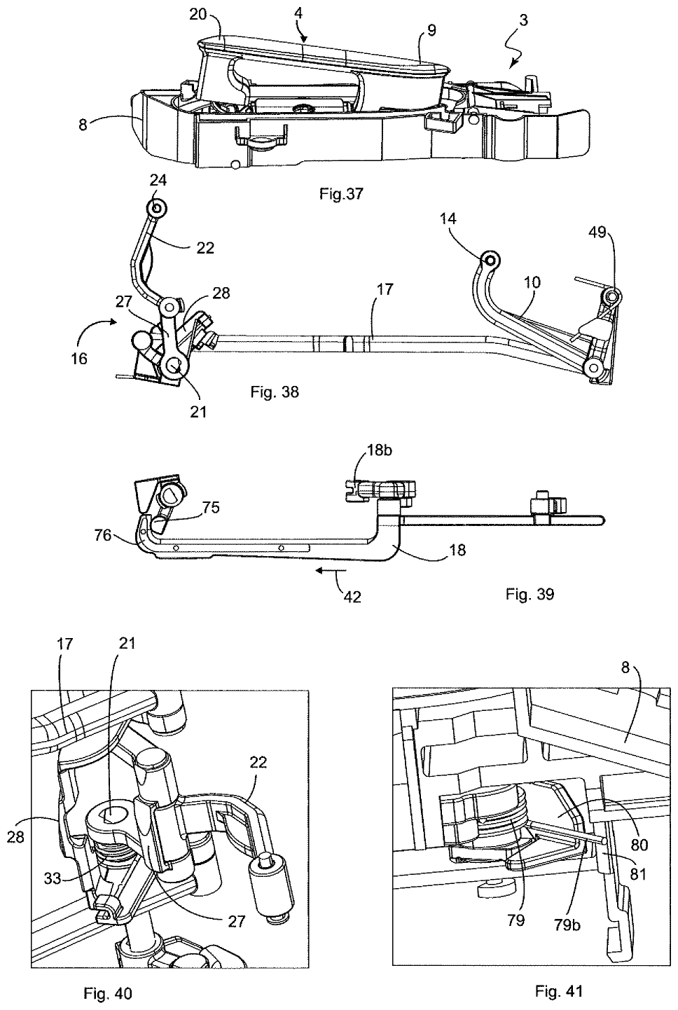

FIG. 37 shows a side view of the door handle assembly when the handle is arranged in an opening position or an emergency actuated position,

FIG. 38 shows a top view of the lever system when the handle is arranged in the opening position or the emergency actuated position,

FIG. 39 shows a bottom view of the lever system when the handle is arranged in the opening position or the emergency actuated position,

FIG. 40 shows a detailed view of the lever mechanism when the handle is arranged in the opening position or the emergency actuated position,

FIG. 41 shows an additional detailed view of the lever mechanism when the handle is arranged in the opening position or the emergency actuated position,

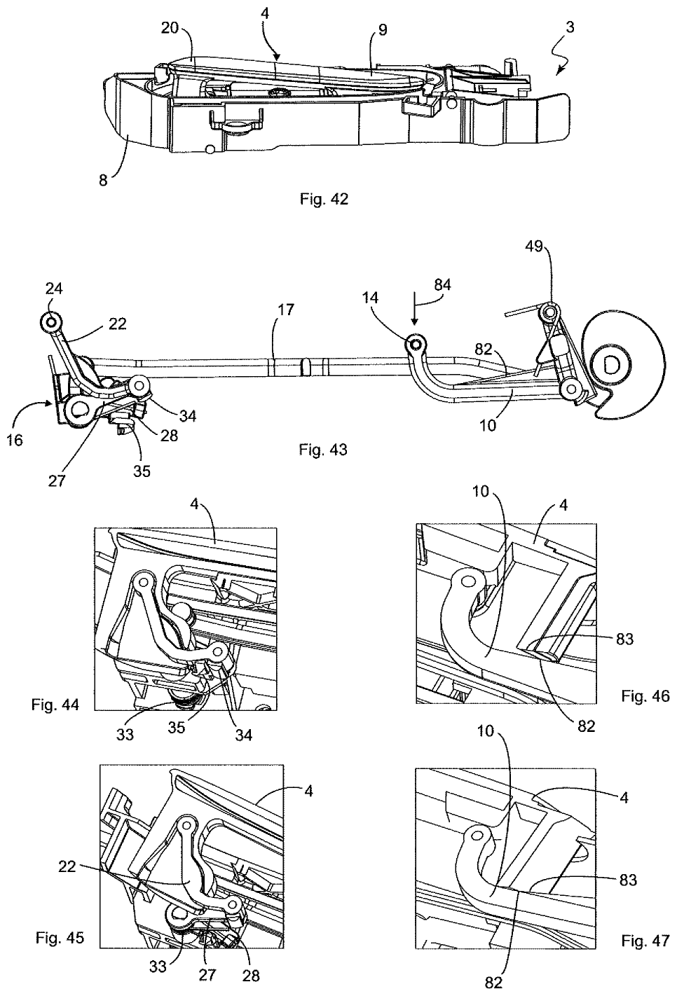

FIG. 42 shows a side view of the door handle assembly according to the invention, when the handle is arranged in an emergency handling position,

FIG. 43 shows a top view of the lever system when the handle is arranged in the emergency handling position,

FIG. 44 shows a detailed view of the lever mechanism when the handle is arranged in the non-use position,

FIG. 45 shows an additional detailed view of the lever mechanism when the handle is arranged in the emergency handling position,

FIG. 46 shows a detailed view of the lever element when the handle is arranged in the non-use position,

FIG. 47 shows an additional detailed view of the lever element when the handle is arranged in the emergency handling position,

FIG. 1 shows an example of a vehicle or motor vehicle 1 in the shape of a passenger car, which in the example has four vehicle doors 2 (two of which are shown in FIG. 1) which can be opened by a door handle assembly 3 and in particular with the aid of a door handle or of a handle 4. The vehicle doors 2 are firmly locked via a respective door lock 5, which is formed in the manner of a rotary-latch lock and can only be opened or unlocked from the outside via a respective movement of the handle 4. This movement on the handle 4 consists of a pulling movement, wherein the corresponding movement of the handle 4 is transmitted to the corresponding lock 5 via a Bowden cable system 6. The associated vehicle door 2 can be opened with the corresponding movement of the handle 4, wherein a slight pulling movement is sufficient for the Bowden cable system 6 to be electrically operated to unlock the door lock 5 in the case of an electrically powered normal operation. In the case of an electroless emergency operation, the door handle assembly 3 according to the invention is formed, so that manual unlocking of the door lock 5 and thereby manual opening of the vehicle door 2 is possible by an operator actuating the handle 4.

FIG. 2 shows in perspective view one of the vehicle doors 2 and the handle 4 which serves for opening of the vehicle door 2. In FIG. 2 the handle 4 is arranged approximately flush to the outer contour 7 of the vehicle door 2, i.e. extends strake-flush, when the door handle assembly 3 is installed in the vehicle door 2. In this position, the handle 4 is in a non-use position in which it is not used. From the non-use position shown in FIG. 2, it is possible to transfer the handle 4 to an actuated position in which it protrudes relative to the outer contour 7 of the vehicle door 2. Accordingly, the handle 4 in its actuated position is arranged to protrude from the vehicle door 2. In this protruding or from the outer contour 7 extended actuated position, an operator can reach behind the handle 4 and operate or handle it to open the vehicle door 2 or to unlock the on-board door lock 5. According to the present invention, the transfer of the handle 4 from the non-use position to the actuated position can occur either in an electrically powered normal operation by means of a suitable drive means or in an electroless emergency operation by means of manual actuation by the operator, which is described in detail below. For the electrically powered normal operation, proximity sensors or other sensors may be provided to bring the handle 4 from the strake-flush or area-flush mounted non-use position to the actuated position as soon as an operator approaches the door handle assembly 3 or the handle 4.

In FIGS. 3 to 20c the door handle assembly 3 is shown in different views and is shown in detail for certain details. The door handle assembly 3 has a handle housing 8 next to the handle 4, which when installed is fastened to the inside of the vehicle door 2 and serves, among other things, to mount the handle 4 so that the handle 4 in its non-use position is arranged to extend strake-flush with the outer contour 7 of the vehicle door 2 and can be moved into its actuated position for actuation by an operator, wherein the handle 4 protrudes in its actuated position relative to the outer contour 7 of the vehicle door 2 and the operator can reach behind and actuate it for opening the vehicle door 2 in order to unlock the door lock 5 formed in the manner of a rotary-latch lock. FIG. 3 shows the door handle assembly 3 in a perspective front view, wherein the handle 4 is in its non-use position. The rear view of the door handle assembly 3 shown in FIG. 4 illustrates the compact construction of the door handle assembly 3, which requires little installation space. This compact structure is realized among other things by a complex lever system 15, which comprises a lever element 10, a lever mechanism 16 and a movement transmission bracket 17, as shown for example in the representation of individual parts in FIG. 5. The lever system 15 is further shown in a top view in FIG. 8 and in a perspective representation of individual parts in FIG. 9. The lever element 10, the lever mechanism 16 and the movement transmission bracket 17 are mounted on the handle housing 8, which is described in detail below. The handle 4 is bound to the handle housing 8 by means of the lever system 15. Further, as shown in FIG. 5 on the basis of the representation of the individual parts, the door handle assembly 3 comprises a vehicle door opening lever 18 and an actuating element 19, which are also each mounted on the handle housing 8.

According to the synopsis of the FIGS. 3 to 47, a first longitudinal end 9 of the handle 4 is connected to the handle housing 8 via the lever element 10. More precisely, a first lever end 11 of the lever element 10 is attached to a lever rotational axis 12, which is rotatably mounted on the handle housing 8, wherein a second lever end 14 of the lever element 10 is rotatably connected to the first longitudinal end 9 of the handle 4. The second lever end 14 of the lever element 10 is accordingly movably coupled to the first longitudinal end 9 of the handle 4 when the lever element 10 rotates around the lever rotational axis 12, which is described more precisely in the following description. For example, as shown in FIGS. 9 and 10, the lever element 10 is formed with a single arm and angled and has a U-shaped form with its angled arm in top view (see for example FIGS. 16 to 18). A second longitudinal end 20 of the handle 4 is bound to the handle housing 8 via the lever mechanism 16. Thereby, the lever mechanism 16 is rotatably mounted on the handle housing 8 via a rotational axis 21 so that the second longitudinal end 20 of the handle 4 is movably fastened to the handle housing 8 via the lever mechanism 16. As shown, for example, in FIGS. 5, 9, 11 and 12, the rotational axis 21 for the present design example is formed by two portions of the rotational axis, with a handle lever 22 between the two portions of the rotational axis 21.

The lever mechanism 16 is shown in more detail in FIGS. 11 to 15 and comprises the handle 22 and a lever body 23 rotatably mounted on the rotational axis 21. The handle lever 22 is formed single-armed and angled, wherein a first end 24 of the handle lever 22 is rotatably connected with the second longitudinal end 20 of the handle 4. The handle lever 22 is arranged between the two portions of the rotational axis 21, which results in a very compact construction form. A second end 25 of the handle lever 22 is rotatably connected to the lever body 23 via a pivot point 26, as for example shown in FIG. 15. The lever body 23 itself has a passive lever 27 and an active lever 28. A first end 29 of the passive lever 27 and a first end 30 of the active lever 28 are mounted on the rotational axis 21, which is mounted on the handle housing 8 (see for example FIG. 12). Thereby, the second end 25 of the handle lever 22 is rotatably connected to a second end 31 of the passive lever 27, whereas the first end 29 of the passive lever 27 is connected to the rotational axis 21 in a torque-proof manner (see for example FIG. 11). However, the first end 30 of the active lever 28 is rotatably connected to the rotational axis 21, so that the active lever 28 is rotatably mounted on the rotational axis 21 relative to the same. From the first end 30 of the active lever 28, a lever-arm-shaped connecting web 32 protrudes radially. If the connecting web 32 is regarded as the lever arm of the active lever 28, the active lever 28 can also be regarded as a two-armed lever with a first active lever arm 28a, which corresponds to the connecting web 32, and a second active lever arm 28b (see for example FIG. 18). What is special about the lever mechanism 16 is the aspect that the passive lever 27 and the active lever 28, which form the lever body 23, perform as a single lever during certain operating processes of the door handle assembly 3 and rotate together around the rotational axis 21, whereas for certain operating conditions of the handle 4 the passive lever 27 and the active lever 28 rotate relative to each other around the rotational axis 21 and perform correspondingly as separate levers. For this purpose, the lever mechanism 16 has a holding element 33, which exerts a holding force on the passive lever 27 and the active lever 28. The holding element 33 is arranged between the first end 29 of the passive lever 27 and the first end 30 of the active lever 28 and is held between the two ends 29, 30 (see for example FIG. 12). The passive lever 27 has an abutment portion 34, whereas on the active lever 28 a counter abutment portion 35 is formed, as shown for example in FIG. 15. The holding element 33 exerts a holding force on the passive lever 27 and the active lever 28, whereby the abutment portion 34 of the passive lever 27 is pressed against the counter abutment portion 35 of the active lever 28. When a force greater than the holding force of the holding element 33 is acting on the lever body 23 consisting of the passive lever 27 and the active lever 28, then the passive lever 27 can be rotated relative to the active lever 28 around the rotational axis 21, otherwise the passive lever 27 and the active lever 28 form a common lever and rotate together around the rotational axis 21. Consequently, the holding element 33 allows the passive lever 27 to move relative to the active lever 28 against the holding force exerted by the holding element 3 so that the abutment portion 34 of the passive lever 27 is spaced apart from the counter abutment portion 35 of the active lever 28. In the design example shown in the figures, the holding element 33 is formed as an elastic spring element 36, wherein a first leg 36a of the spring element 36 engages in a hook-shaped holding lug 37 formed on the passive lever 27 and a second leg 36b of the spring element 36 engages in a hook-shaped holding piece 38 formed on the active lever 28, as can be seen for example from the FIGS. 11 to 15. The spring element 36 is configured wound around a portion of the rotational axis 21, as shown in FIGS. 11 and 12. FIG. 14 shows a position of the passive lever 27 and the active lever 28 in which the abutment portion 34 of the passive lever 27 abuts on the counter abutment portion 35 of the active lever 28, whereas FIG. 15 shows a different position in which the abutment portion 34 of the passive lever 27 is spaced apart from the counter abutment portion 35 of the active lever 28, which shows that the passive lever 27 and the active lever 28 are rotatably mounted relative to each other.

The FIGS. 16 to 18 show different assemblies of the individual parts of the lever system 15 depending on the position of the handle, wherein for reasons of clarity only the parts of the lever system 15 are shown in a top view and the other parts of the door handle assembly 3 are omitted. The FIGS. 19a to 20c further show different assemblies of the lever element 10 and the lever mechanism 16. The FIGS. 16, 19a and 20a show assemblies in which the handle is arranged in a non-use position extending strake-flush with the outer contour 7. In the FIGS. 17, 19b and 20b, however, the handle 4 is arranged in an actuated position, in which the handle 4 is arranged exposed relative to the outer contour 7 of the vehicle door 2. In the FIGS. 18 and 20c the handle 4 is then shown in each case in a position in which an operator pulls the handle 4 for opening the vehicle door 2. The FIGS. 16 to 18 show, among other things, that the lever element 10 is connected to the lever mechanism 16 in a movably coupled manner via the movement transmission bracket 17. Thereby, a first longitudinal end 39 of the movement transmission bracket 17 is rotatably connected to the lever element 10 at a distance or spaced apart from the lever rotational axis 12. A second longitudinal end 40 of the movement transmission bracket 17 is also rotatably connected to the lever mechanism 16 at a distance or spaced apart from the rotational axis 21. More precisely, the second longitudinal end 40 of the movement transmission bracket 17 is rotatably connected to the free end of the connecting web 32 or to the first active lever arm 28a of the active lever 28. The first longitudinal end 39 of the movement transmission bracket 17 is rotatably connected to the lever element 10 with a lever rotational axis distance 73 from the lever rotational axis 12, whereas the second longitudinal end 40 of the movement transmission bracket 17 is rotatably connected to the lever mechanism 16 with a lever rotational axis distance 74 from the lever rotational axis 21 (see for example FIG. 8), wherein the lever rotational axis distance 73 has a greater length than the rotational axis distance 74. When the handle 4 is moved from its non-use position shown in FIGS. 16, 19a and 20a to the actuated position shown in FIGS. 17, 19b and 20b, then the lever element 10 rotates clockwise according to the arrow 41 around the lever rotational axis 12, following which the movement transmission bracket 17 articulately connected to the lever element 10 moves in the direction of the lever mechanism 16 or in the direction of the second longitudinal end 20 of the handle 4 (see arrow 42 in FIG. 17) around the lever rotational axis 12. Further, the second lever end 14 of the lever element 10, to which the first longitudinal end 9 of the handle 4 is mounted in an articulated manner, swivels around the lever rotational axis 12, whereby the handle 4 is moved from its strake-flush non-use position into the actuated position and protrudes from the outer contour 7 of the vehicle door 2, so that an operator can reach behind the handle 4 for actuation. The movement of the movement transmission bracket 17 in the direction of the lever mechanism 16 or in the direction of the second longitudinal end 20 of the handle 4 (see arrow 42 in FIG. 17) effects that the lever mechanism 16 rotates counterclockwise around the rotational axis 21 (see arrow 43 in FIG. 17). This rotational movement is effected by the movement transmission bracket 17, whose second longitudinal end 40 is movably coupled and articulated to the connecting web 32 or the first active lever arm 28a of the active lever 28. During this rotational movement of the lever mechanism 16, the holding force of the holding element 33 is sufficient enough so that the holding element 33 presses the abutment portion 34 of the single-arm formed passive lever 27 against the counter abutment portion 35 of the active lever 28. However, during this rotational movement of the lever mechanism 16 the handle lever 22 swivels out, which is connected with its first end 24 articulately to the handle 4 and which is connected with its second end 25 articulately to the second end 31 of the passive lever 27. The swiveling out movement of the lever 22 causes also the second longitudinal end 20 of the handle 4 to be exposed from the outer contour 7 of the vehicle door 2. During the movement of the handle 4 from the non-use position into the actuated position, the handle 4 is first moved out at its first longitudinal end 9 and then the handle 4 is moved out at its second longitudinal end 20 from the outer contour 7 of the vehicle door 2 due to shorter lever lengths of the lever element 10 relative to the lever length of the lever mechanism 16, wherein the handle 4 is moved out at its first longitudinal end 9 less far than at its second longitudinal end 20 from the outer contour 7. To be more precise, during a movement from the non-use position into the actuated position, the handle 4 is exposed at its first longitudinal end 9 by approx. 28 mm and at its second longitudinal end 20 by approx. 44 mm, whereby the handle 4 in its actuated position is not arranged parallel to, but at an angle to, the outer contour 7 of the vehicle door 2. The angled assembly of the handle 4 in its actuated position is made possible among other things by the fact that a handle lever leg 44 terminating at the first end 24 of the handle lever 22 is formed with a handle lever length 45 which is at least 1.25 times greater than a lever element length 46 of a lever element leg 47 terminating at the second lever end 14 of the lever element 10 (see for example FIGS. 19a and 20c). When the handle 4 is actuated by an operator from the actuated position then this is a pulling movement on the handle 4, causing it to reach the position shown in FIGS. 18 and 20c. In this position, the lever element 10 remains arranged in the position in which it had already arrived in the actuated position. Consequently, there is no additional rotation around the lever rotational axis 12. Instead, a relative movement occurs at the lever mechanism 16 between the passive lever 27 and the active lever 28, wherein the operator must apply a force to the handle 4 during his pulling movement which is greater than the holding force of the holding element 33. If this is the case, the operator's force effected on the handle 4 moves the passive lever 27 relative to the active lever 28, wherein the active lever 28 remains in the location it has already occupied in the actuated position of the handle. As shown in FIGS. 18 and 20c, the abutment portion 34 of the passive lever 27 is spaced apart from the counter abutment portion 35 of the active lever 28, as shown by arrow 48 in FIG. 20c. The passive lever 27 therefore occupies an extended position pointing to the handle 4 relative to its location in the actuated position of the handle, in which the second longitudinal end 20 of handle 4 protrudes even more from the outer contour 7 of vehicle door 2. To be more precise, in FIG. 20c, the passive lever 27 and the handle lever 22 occupy respective positions, which present a maximum extension of these two levers 22, 27, because both levers 22, 27 are arranged aligned transversely to the handle housing 8 or to the movement transmission bracket 17, so that this assembly realizes a maximum deflection of the second longitudinal end 20 of the handle 4. Therefore, it is characteristic for the lever system 15 of the door handle assembly 3 according to the invention that during a movement of the handle 4, the second lever end 14 of the lever element 10 is arranged at a constant spacing from the lever rotational axis 12, whereas the first end 24 of the handle lever 22 is arranged at a varying spacing from the rotational axis 21 depending on the movement position of the handle 4.

The operation of the door handle assembly 3 according to the invention and other technical features of the invention are described below.

In FIGS. 21 to 24 the handle 4 of the door handle assembly 4 is arranged in its non-use position, in which the handle 4 is arranged to extend strake-flush with the outer contour 7 of the vehicle door 2. In other words, the handle 4 in its non-use position is positioned area-flush mounted in a door panel representing the outer contour 7. A mechanical restoring element 49 pushes the handle 4 into its non-use position and holds it in this position as shown in FIG. 21, wherein the mechanical restoring element 49 allows a movement of the handle 4 from the non-use position towards the actuated position against a restoring force produced by the mechanical restoring element 49. In the design example shown, the mechanical restoring element 49 is formed as a return spring 50 which is wound around the lever rotational axis 12 (see for example FIGS. 9 and 10). Thereby, a first spring leg 50a of the return spring 50 is supported on the handle housing 8, whereas a second spring leg 50b of the return spring 50 is supported on the lever element 10. The handle 4 is therefore pressed by means of the return spring 50 into the non-use position against the seals and end stops not shown in the figures. However, an injury of the operator's hand is not possible when the handle 4 is held, since the restoring force of the return spring 50 is not dimensioned so strongly that a serious jamming of the operator's hand would be possible. The synopsis of the FIGS. 22 to 24 shows some of the many peculiarities of the door handle assembly 3 according to the invention on the basis of the non-use position of the handle 4. In FIG. 22, the handle housing 8 is omitted for more clarity. As shown in FIG. 22, the lever element 10 is movably coupled with the lever mechanism 16 via the movement transmission bracket 17, so that a rotation of the lever element 10 around the lever rotational axis 12 causes a rotation of the lever mechanism 16 around the rotational axis 21. The vehicle door opening lever 18, which is formed bar-shaped, is mounted on the handle housing 8 so as to be movable parallel to the movement transmission bracket 17 via two articulation points 18a, wherein a Bowden cable lever 18b protrudes radially from one of the two articulation points 18a, to which a Bowden cable is fastened, which again is connected to the door lock 5 of the vehicle door 2 and serves in a known manner to unlock the door lock 5. According to the invention, the lever element 10 and the lever mechanism 16 are disengaged from the movement transmission bracket 17 when the handle 4 is in the non-use position. Meaning, in the non-use position of the handle 4, the lever element 10 and the lever mechanism 16 are decoupled from the movement transmission bracket 17, whereby the invention differs from the known prior art, where there is a durable and permanent connection between the handle and the Bowden cable for all positions of the handle. In the non-use position of the handle 4, the movement transmission bracket 17 is arranged in a standby position (see for example FIG. 22) from which it can be moved into an unlocking position in order to unlock the door lock 5, which is formed in the manner of a rotary-latch lock. Another special feature of the invention, apart from the decoupling of the Bowden cable lever 18 from the handle 4 in its non-use position, is that also in the non-use position of the handle 4, a motor-driven actuating element 19 has no firm connection to the lever element 10 and the lever mechanism 16. In other words, the motor-driven actuating element 19 is decoupled from the lever element 10 and the lever mechanism 16 when the handle 4 is in the non-use position and has no firm connection to the lever element 10 and the lever mechanism 16. The actuating element 19 therefore does not engage with the lever element 10 and with the lever mechanism 17 when the handle 4 is in its non-use position. The motor-driven actuating element 19 is mounted on the handle housing, wherein a motor drive axis 51 of an electric motor drives and rotates the actuating element 19. According to the invention, when the handle 4 is in the non-use position, both the movement transmission bracket 17 used to unlock the door lock 5 and the actuating element 19 are decoupled from the lever element 10 and the lever mechanism 16. In the non-use position of the handle 4, the actuating element 19 occupies a rest position shown in FIGS. 23 and 24.

With respect to FIGS. 25 to 29, different views are shown for an electrically powered normal operation of the door handle assembly 3 according to invention. In an electrically powered normal operation of the door handle assembly 3, an approximation of an authorized operator to the vehicle 1 is recognized in a known manner by a vehicle controlling unit, whereupon a signal is sent from the vehicle controlling unit to the electromotor, which then starts its operation and rotates the actuating element 19 via the motor drive axis 51. The electromotor is energized for a predetermined period of time and rotates the actuating element 19 around the motor drive axis 51 by an angle in a range from 90° to 130°. Thereby, the actuating element 19 moves from its rest position into a handle extension position shown in FIGS. 26 and 27. The actuating element 19 is thereby rotatably mounted on the handle housing via the motor drive axis 51. As shown in FIGS. 26 and 27 in synopsis with FIGS. 6 and 7, the motor-driven actuating element 19 is discoidal with a non-uniform edge 52. When the actuating element 19 is rotated around the motor drive axis 51, in which the actuating element 19 is rotated from its rest position to its handle extension position, the non-uniform edge 52 cooperates with a leverage 10a formed on the lever element 10. The non-uniform edge 52 has a first edge portion 53 with a radius increasing from a minimum radius 54 to a maximum radius 55 and a second edge portion 56 with a maximum radius 55. Especially in FIGS. 6 and 26 it can be recognized that the maximum radius 55 is larger than the minimum radius 54. The non-uniform edge 52 further has a third edge portion 57 with the minimum radius, wherein the third edge portion 57 is formed in front of the first edge portion 53 and the second edge portion 56 extends between the first edge portion 53 and the third edge portion 58. Thereby, the transition from the second edge portion 56 to the third edge portion 57 is formed abruptly. In the electrically powered normal operation, the motor-driven actuating element 19 rotates the lever element 10 counterclockwise from its rest position around the lever rotational axis 12, as shown by the arrow 58 in FIG. 26, wherein the rotation is a uniform handle-exposition rotational movement of the motor-driven actuating element 19. During this uniform handle-exposition rotational movement of the motor-driven actuating element 19 from the rest position into the handle extension position, the first edge portion 53 presses with increasing radius against the leverage 10a of the lever element 10 and consequently moves the handle 4 via the lever element 10 from the non-use position into its actuated position shown in FIG. 25, in which the handle 4 protrudes relative to the outer contour 7 of the vehicle door 2. The uniform handle-exposition rotational movement of the motor-driven actuating element 19 stops when the second edge portion 56 of the motor-driven actuating element 19 abuts against the leverage 10a of the lever element 10. The motor drive axis 51 rotates the actuating element 19 by means of the uniform handle-exposition rotational movement at an angle in a range from 90° to 130°, which ensures that the leverage 10a abuts against the second edge portion 56, so that the first longitudinal end 9 of the handle 4 is arranged in an exposed position relative to the outer contour 7 of the vehicle door 2. It should be noted that the leverage 10a of the lever element 10 abuts on the third edge portion 57 when the handle 4 is in the non-use position and the motor-driven actuating element 19 is in the rest position, as shown in FIG. 23. Referring to FIGS. 25 to 29, it is to be noted that the vehicle opening lever 18, arranged in the actuated position of the handle 4, is still arranged in the standby position in which the Bowden cable lever 18b does not unlock the door lock 2. The reason for this is an unlocking contour 59, which is formed on one of the two side surfaces (upper side or lower side) of the discoidal formed and motor-driven actuating element 19. The unlocking contour 59 interacts with the vehicle door opening lever 18 during a movement of the actuating element 19 from the handle extension position into the door opening position. As shown in FIG. 7, the unlocking contour 59 has a first contour portion 60 with a constant neutral radius 61, a second contour portion 62 with a progression radius 63 and a third contour portion 64 with a constant radius 65. The constant radius 65 is larger than the neutral radius 61, wherein the constant radius 65 and the neutral radius 61 each have a constant radius. Further, the progression radius 63 is a radius that increases from the neutral radius 61 to the constant radius 65. As shown in FIGS. 26 and 27 in synopsis with FIGS. 6 and 7, the constant radius 65 of the unlocking contour 59 is smaller than the maximum radius 55 of the non-uniform edge 52 of the motor-driven actuating element 19. As an alternative to the unlocking contour formed on the actuating element 19, it is also conceivable that a cam disc, additionally to and separately from the motor-driven actuating element 19, is mounted rotatably on the handle housing 8 via the motor drive axis 51, wherein the cam disc interacts with the vehicle door opening lever 18 in order to move the vehicle door opening lever 18 from the standby position into an unlocking position, wherein the unlocking position is discussed below. In the electrically powered normal operation of the door handle assembly, the first contour portion 60 with neutral radius 61 tangentially moves past a longitudinal end 66 of the vehicle door opening lever 18 (see FIG. 27) during a rotational movement of the motor-driven actuating element 19 when it rotates from the rest position into the handle extension position, so that the vehicle opening lever 18 remains in the standby position. The uniform handle-exposition rotational movement of the actuating element 19 causes—as described above—a rotation of the lever element 10 around the lever rotational axis 12, whereby, firstly, the handle 4 is exposed at its first longitudinal end 9 and, secondly, the movement transmission bracket 17, which is movably coupled and rotatably connected with its first longitudinal end 39 to the lever element 10, is moved in the direction of the lever mechanism 16 (see arrow 67). Further, at the end of the uniform handle-exposition rotational movement of the actuating element 19, the second longitudinal end 40 of the movement transmission bracket 17 abuts on the handle housing 8. Consequently, the actuating element 19 presses the second longitudinal end 40 of the movement transmission lever 17 at least in portions against a locking stop 67 fastened to the handle housing 8 (see FIG. 29), so that the movement transmission lever 17 with its second longitudinal end 40 is secured and abutted against the handle housing 8 in a wobble-free and tilt-free manner. Further, the motor-driven actuating element 19 presses a support lug 68 formed on the lever element 10 at least in portions against a support stop 69 formed on the handle housing 8 (see FIG. 28), so that the movement transmission lever 17 with its first longitudinal end 39 is also secured and abutted against the handle housing 8 in a wobble-free and tilt-free manner. Due to the movement of the movement transmission bracket 17 parallel to the handle housing 8 as a result of the clockwise rotation of the lever element 10 around the lever rotational axis (see arrow 41), the movement transmission bracket 17 rotates the lever mechanism 16 counterclockwise around the rotational axis 21 (see arrow 43), as already described for FIG. 17, to which reference is made here to avoid repetitions. The movement transmission bracket 17 interacts with the active lever 28 and rotates the active lever 28 around the rotational axis 21. Thereby, the passive lever 27 and the active lever 28 turn as the common lever body 23 around the rotational axis 21, because the holding force of the holding element 33 presses the abutment portion 34 of the passive lever 27 against the counter abutment portion 35 of the active lever 28, wherein the passive lever 27 abuts during this rotational movement on support surfaces 70 (see for example FIG. 13), which abut on the passive lever 27 during the rotational movement, so that the active lever 28 rotates together with the passive lever 27 when the actuating element 19 rotates from its rest position into the handle extension position. The force transmitted to the lever mechanism 16 by the movement of the movement transmission bracket 17 causes the handle lever 22 to occupy the location shown in FIGS. 26 and 29. The first end 24 of the handle 22 cannot move differently due to its coupling with the handle 4 and moves away from the rotational axis 21, whereby the second longitudinal end 20 of the handle 4 is also arranged exposed out of the outer contour 7 of the vehicle door 2 when the actuating element 19 is arranged in the handle extension position. The binding of the second longitudinal end 20 of the handle 4 is therefore constructed in the manner of a toggle lever, wherein the active lever 28 and the passive lever 27 are held stably in their abutting position against one another at least in the non-use position of the handle 4 by the holding force of the holding element 33, and wherein during the movement of the handle 4 into its actuated position the supporting surfaces 70 of the active lever 28 also move the passive lever 27 when the lever mechanism 16 rotates around the rotational axis 21. As a result of the different length elaborations of the handle lever length 45 of the handle lever 22 and the lever element length 46 of the lever element 10, the first longitudinal end 20 of the handle 4 is exposed from the outer contour 7 of the vehicle door 2 to the second longitudinal end 20 of the handle 4 when the handle 10 is exposed from its non-use position into its actuated position in the electrically powered normal operation. This time-delayed extension movement of the two longitudinal ends 9 and 20 of the handle realizes a better breaking-free of the handle 4 in case of icing. The time delay is thereby realized as follows. The active lever 28 of the lever body 23 has a support element 71 (see for example FIG. 13), on which the handle lever 22 abuts at least in portions in the non-use position of the handle 4 and when the handle 4 moves in the direction of its actuated position until a slack point 72 is exceeded. Only when the second end 25 of the handle lever 22 has exceeded the slack point 72, the handle lever 22 will raise from the support element 71 and move out the second end 20 of the handle 4. This means that the lever element 10 moves out the first longitudinal end 9 of the handle 4 from the outer contour 7 using rotation around the lever rotational axis 12 and the lever mechanism 16 moves out the second longitudinal end 20 from the outer contour 7 using rotation around the rotational axis 21 only after the slack point 72 of the handle lever 22 has been exceeded, although the lever element 10 is movably coupled to the lever mechanism 16 so that, when the handle 4 is moved from the non-use position into the actuated position, the lever element 10 rotates around the lever rotational axis 12 and at the same time the lever mechanism 16 rotates around the rotational axis 21. Further, the handle 4 is not only swiveled out vertically to the handle housing 8, but also transversely to this direction, which supports the better breaking-free. The handle 4 is moved out during the normal operation by the actuating element 19 until the movement transmission bracket 17 abuts on the locking stop 67 and the support lug 68 abuts on the support stop 69. As a result, the movement transmission bracket 17 is held in location between the actuating element 19 and the locking stop 67 in a wobble-free manner. Due to the different lever lengths, the handle 4 moves out approx. 28 mm at its first longitudinal end 9 and approx. 40 mm at its second longitudinal end 20, so that the handle 4 in its actuated position is arranged diagonally to the outer contour 7 and to the handle housing 8. Because of the compact lever system 15 and its compact lever movement when the handle 4 is moved out, installation space can be saved in critical areas such as the window guide of the vehicle door 2. It is characteristic for the door handle assembly 3 that during a movement of the handle 4, the second lever end 14 of the lever element 10 is arranged at a constant spacing from the lever rotational axis 12, whereas the first end 24 of the handle lever 22 is arranged at a varying spacing from the rotational axis 21 depending on the movement position of the handle 4. For the operation of the door handle assembly 3 with the handle 4 bound to the handle housing 8 via the lever element 10 and the lever mechanism 16, it is characteristic, among other things, that during the movement from the non-use position into the actuated position the first longitudinal end 9 of the handle 4 is moving out from the lever element 10 out of the outer contour 7 of the vehicle door 2 and the second longitudinal end 20 of the handle 4 is moving out from the lever mechanism 16 with a time delay to the first longitudinal end 9 of the handle 4, wherein the second longitudinal end 20 of the handle 4 is moved out further from the lever mechanism 16 than the first longitudinal end 9 of the handle 4 and wherein the first longitudinal end 9 of the handle 4 is moved out at a time prior to the second longitudinal end 20 of the handle 4. During the movement of the handle 4 from its non-use position to the actuated position, the lever mechanism 16 is rotated around the rotational axis 21 until an actuating lug 75 bearing radially from the first end 29 of the passive lever 27 almost engages with a hook-shaped cam portion 76 formed on the vehicle door opening lever 18 as shown in FIG. 27. Contrary to the elaboration embodiment described above, in the design example shown, the actuating lug 75 is formed as a separate part which is connected to the rotational axis 21 in a torque-proof manner. When the handle 4 is arranged in the actuated position and the lever mechanism 16 has occupied its corresponding position, a small gap remains between the actuating lug 75 and the cam portion 76.

This small gap between the actuating lug 75 and the cam portion 76 is necessary so that a slight pull on the handle 4 by an operator does not cause the door lock 5 to open mechanically. This is because a slight pull on the handle 4 should have the effect of servo-unlocking the door lock 5. The servo-unlocking effected by the operator should therefore be possible with a reduced force by the operator compared to a purely mechanical unlocking. The servo-unlocking therefore supports the operator during unlocking, whereby the pulling force applied by the operator is detected and the actual unlocking process occurs by the drive motor. The FIGS. 30 to 36 show assemblies of the individual parts of the door handle assembly 3 when the handle 4 is moved from the actuated position into a servo-opening position by an operator. The actuation of the operator is thereby a pulling movement on the handle 4, wherein in FIGS. 30 to 36 the handle 4 is arranged in the servo-opening position for an electrically powered normal operation of the door handle assembly 3. During the servo-actuation by the operator, the handle 4, which is arranged in its actuated position, is pulled. Since the handle 4 in its actuated position cannot be moved any further at its first longitudinal end 9, the pulling movement by an operator causes the handle 4 at its second longitudinal end 20 to be pulled further outwards relative to the outer contour 7 and the lever mechanism 16 rotates about 3° around the rotational axis 21, whereby the handle 4 is arranged in the servo-opening position shown in FIG. 30. This rotational movement by the operator, which is transmitted to the passive lever 27 via the handle lever 22, occurs against the holding force of the holding element 33. Thereby, the rotation of the passive lever 27 caused by the operator is effected against a counterforce exerted by a counterforce element 78. The operator therefore experiences an increase in force when the handle 4 is servo-actuated, which is equivalent to a stop collar that can be felt by the operator, so that he will no longer attempt to pull out the handle 4 any further. The counterforce element 78 (see for example FIGS. 35 and 36) can be arranged on a longitudinal portion of the passive lever 27. In the design example shown, the counterforce element 78 is arranged on the actuating lug 75 and is designed as an elastic leg spring element 79, wherein a first leg 79a of the leg spring element 79 is supported on the actuating lug 75 and a second leg 79b of the leg spring element 79 abuts against a hook-shaped holding lug 80 which protrudes radially from the actuating lug 75. The second leg 79b of the leg spring element 79 comes into abutment with a limiting stop 81 formed on the handle housing 8 (see, for example, FIG. 41) during the movement of the handle 4 from the actuated position into the servo-opening position, so that the leg spring element 79 is compressed in the servo-actuated position of the handle 4 to produce the counterforce. The rotation or oscillation of the passive lever 27, which is torque-proof connected to the rotational axis 21, is detected by detection means 77 arranged on the handle housing 8. The detection means 77 is only exemplarily indicated in FIGS. 31 and 33 and can be a Hall sensor, whereby a movement of the handle 4 from the actuated position into the servo-opening position can easily be detected or captured in order to send a corresponding signal to the vehicle controlling unit or directly to the drive motor, wherein the drive motor then moves the actuating element 19 from its handle extension position (see FIGS. 31, 32 and 35) into a door opening position (see FIGS. 33, 34 and 36), thereby moving the vehicle door opening lever 18 from its standby position with the actuating element 19 into an unlocking position in which the vehicle door 2 can be opened. However, other sensors or detection means are also conceivable in order to detect a movement of the handle 4 and to activate a drive motor for moving the actuating means 19. The motor-driven actuating element 19, which is movably coupled to the lever element 10, is therefore mounted on the handle housing 8 so that it can move from the rest position via the handle extension position into the door opening position. The detection means 77 is formed in such a manner that it effects a movement of the motor-driven actuating element 19 from the handle extension position into the door opening position upon detection of a movement of the handle 4 from the actuated position into the servo-opening position. While FIGS. 31 and 33 show a top view of the individual levers and the actuating element 19 of the door handle assembly 3, FIGS. 32 and 34 show a bottom view of the actuating element 19, the actuating lug 75, which is torque-proof bound to the rotational axis 21, and the vehicle door opening lever 18. The motor-driven actuating element 19 is coupled to the vehicle door opening lever 18 mounted on the handle housing 8 to be movable between the standby position and the unlocking position. When the motor-driven actuating element 19 moves from the handle extension position (see, for example, FIG. 31) into the door opening position (see, for example, FIG. 33), it moves the vehicle door opening lever 18 from the standby position to the unlocking position into which the vehicle door 2 can be opened. The movement of the motor-driven actuating element 19 from the rest position via the handle extension position into the door opening position is a rotational movement around the motor drive axis 51. During the rotational movement of the actuating element 19 from the handle extension position into the door opening position, the unlocking contour 59 cooperates with the longitudinal end 66 of the vehicle door opening lever 18, while the second edge portion 56 of the non-uniform edge 52 with its constant maximum radius 55 holds the lever element 10 in place. By means of the detection means 77, the rotation of the passive lever 27 is detected, whereupon the drive motor is started again and the actuating element 19 continues to rotate counterclockwise (see arrow 58 in FIG. 33). This rotation corresponds to a door unlocking rotational movement of the motor-driven actuating element 19 from the handle extension position into the door opening position, in which the second contour portion 62 and then the third contour portion 64 of the unlocking contour 59 press against the longitudinal end 66 of the vehicle door opening lever 18 and urge the vehicle door opening lever 18 from its standby position into its unlocking position to open the vehicle door 2, as shown in FIG. 34. The door unlocking rotational movement then stops just before the third edge portion 57 of the motor-driven actuating element 19 reaches the lever lug 10a of the lever element 10. Before that, however, the door lock 5 is already unlocked, so that a detection of the door lock unlocking can be used to stop the drive motor. The standby position is shown in FIG. 35, whereas FIG. 36 shows the unlocking position of the vehicle door opening lever 18. In the unlocking position, the Bowden cable lever 18b is pivoted around its articulation point 18a so that the movement of the vehicle door opening lever 18 caused by the motor-driven actuating element 19 during normal operation causes a pulling movement on a Bowden cable attached thereto, whereby the door lock 5 is unlocked and the vehicle door 2 can be opened. After the servo-actuation by the operator, the handle 4 returns to its actuated position as a result of the holding force of the holding element 33. After opening the vehicle door 2 or after a predetermined period of time or on the basis of a corresponding signal from an electronic vehicle key, the handle 4 is then moved back to its non-use position, wherein for this purpose the actuating element 19 is rotated back to its rest position, so that the handle 4 reaches its non-use position by means of the restoring force of the return spring 50.

As mentioned above, the vehicle door opening lever 18 mounted on the handle housing 8 can be moved between the standby position and the unlocking or opening position of vehicle door 2. The movement to the unlocking position for an electrically powered normal operation of the door handle assembly 3 is described above. However, the vehicle door opening lever 18 can also be moved into the unlocking position in an electroless emergency operation, which is done by the operator actuating the handle 4. This situation is shown in FIGS. 37 to 41. The handle 4 is movably mounted for emergency operation, which can occur in the case of malfunction of the electrical supply of the vehicle 2 or malfunction of the drive motor, whereby the operator can move the handle from the actuated position to an opening position, also referred to as an emergency actuated position, for manual opening of the vehicle door. In FIG. 37, the handle is arranged in this emergency actuated position, which is a position in which the handle is extended from the actuated position via the servo-opening position out of the outer contour 7 of the vehicle door 2. The description above for normal operation shows that the handle 4 is decoupled from the vehicle door opening lever 18 in its non-use position and in its actuated position. In the case of the door handle assembly 3 according to the invention, the handle 4 couples in an emergency operation with the vehicle door opening lever 18 during a movement from the actuated position into the emergency actuated position, wherein the handle 4 moves the vehicle door opening lever 18 into the unlocking position, as indicated by arrow 42 in FIG. 34. In particular, the handle 4 couples with the vehicle door opening lever 18 during a movement from the actuated position to the emergency actuated position. In emergency operation, during the movement of the handle 4 from the actuated position in the direction of the emergency actuated position, the actuating lug 75 engages in the cam portion 76 and pushes the vehicle door opening lever 18 from the standby position into the unlocking position (see FIG. 39). By pulling the handle 4, the lever mechanism 16 is rotated around the rotational axis 21 by about 7°, wherein this movement takes place against the holding force of the holding element 33 and against the counterforce of the leg spring element 79. The operator must therefore apply a much higher force relative to normal operation to move the handle 4 to the emergency actuated position and rotate the Bowden cable lever 18b to unlock the door lock 5. By overcoming the holding force of the holding element 33, the passive lever 27 is rotated away from the active lever 28 so that the passive lever 27 does not abut on the active lever 28 anymore (see for example FIG. 40). Additionally, the operator must move the handle 4 against the counterforce of the leg spring 79 to push the vehicle door opening lever 18 into the unlocking position. During this movement of the handle 4 in the direction of the emergency actuated position, the second leg 79b of the leg spring element 79 comes into contact with the limiting stop 81 formed on the handle housing 8, whereby the leg spring element 79 in the emergency actuated position of the handle 4 is compressed to produce the counterforce (see FIG. 41). The actuation of the handle 4 is more difficult than the servo-actuation as a result of the application of the two spring elements 33 and 79. The extended position of the passive lever 27 in FIG. 38 also represents a mechanical end stop, because the handle 4 cannot be moved further than into this position. As a result of the spring force of the door lock 5, the vehicle door opening lever 18 is repeatedly moved back via the Bowden cable to its initial position, i.e. to the standby position, when the force of the operator no longer acts on the handle 4.

The emergency operation of door handle assembly 3 described above assumes that the handle 4 is in its actuated position or in a position in which the operator can engage the handle 4 for actuation. If the handle 4 is in its non-use position and an electroless emergency operation is given, the invention provides for the door handle assembly 3 that in the case of a malfunction of the motor-driven actuating element 19, the handle 4 can be moved by the operator into an emergency handling position shown in FIG. 43. In the emergency handling position, the first longitudinal end 9 of the handle 4 is moved towards the handle housing 8 with respect to the non-use position and the second longitudinal end 20 of the handle 4 is moved away from the handle housing 8. The holding element 33 allows a movement of the first longitudinal end 9 of the handle 4 in the direction of the handle housing 8 and relative to the second lever end 14 of the lever element 10 and a movement of the second longitudinal end 20 of the handle 4 away from the handle housing 8 against the holding force exerted by the holding element 3. This is possible because the binding of the second longitudinal end 20 of the handle 4 is effected via the lever mechanism 16, which is designed in the manner of a toggle lever and in which the passive lever 27 and the active lever 28 are held in a stable and abutting position by the holding force of the holding element 33. The first end 29 of the passive lever 27 is connected to the rotational axis 21 in a torque-proof manner, while the first end 30 of the active lever 28 is rotatably connected to the rotational axis 21. As described above, in the non-use position of the handle 4 the holding element 33 presses the abutment portion 34 of the passive lever 27 against the counter abutment portion 35 of the active lever 28. However, in the emergency handling position of the handle 4, a compressive force exerted by the operator and exceeding the holding force of the holding element 33 acts on the first longitudinal end 9 of the handle 4, whereby the abutment portion 34 of the passive lever 27 is arranged to be rotated away from the counter abutment portion 35 of the active lever 28 (see, for example, FIGS. 43 and 45, wherein FIG. 44 shows a position of the lever mechanism 16 in which the handle 4 is arranged in its non-use position). During the movement from the non-use position into the emergency handling position, the handle 4 transfers a compressive force exerted by the operator at the first longitudinal end 9 (see arrow 84) via the second longitudinal end 20 to the passive lever 27 of the lever mechanism 16, which causes a relative rotation of the passive lever 27 with respect to the active lever 28, so that in the emergency handling position the abutment portion 34 of the passive lever 27 is arranged in a spaced-apart manner from the counter abutment portion 35 of the active lever 28. To prevent unintentional movement of the handle 4 into the emergency handling position, the holding force of the holding element 33 is dimensioned so that the holding element 33 presses the abutment portion 34 of the passive lever 27 against the counter abutment portion 35 of the active lever 28 up to an acceleration force acting in the case of a vehicle accident or up to a compression force of at least 30 g exerted by the operator. In order to prevent the handle 4 from being pressed indefinitely into the outer contour 7 of the vehicle door 2 while overcoming the holding force, the lever element 10 has a supporting lug 82 between its first lever end 11 and its second lever end 14. The supporting lug 82 is located in the emergency handling position on a movement limiting lug 83 formed on the handle 4 and limiting the movement of the handle 4 towards the handle housing 8, as shown in FIG. 47, wherein FIG. 46 shows the position of the handle 4 in its non-use position. Meaning that in this emergency operation, where the handle 4 is in its non-use position, the handle 4 is pressed into its first longitudinal end 9, whereby the second longitudinal end 20 of the handle 4 is unscrewed via the lever mechanism 16. This allows the operator to grasp the handle 4 and pull it completely out of the outer contour 7 of the vehicle door 2 into the emergency actuated position and actuate it mechanically.

Finally, it should be mentioned that the handle 4 is bound in an articulated manner to the lever system 15, in particular to the lever element 10 and to the handle lever 22, at its first longitudinal end 9 and at its second longitudinal end 20 via corresponding screw means. The handle 4 itself can be replaced by loosening the screw means from a position in which the handle 4 is exposed from the outer contour 7 of the vehicle door 2.

Other preferred embodiments of the present invention are described in the following paragraphs:

An additional preferred embodiment of the invention relates to a door handle assembly 3 for a vehicle door 2 with a handle housing 8, which is fastened to the vehicle door 2, a handle 4 mounted on the handle housing 8, which in a non-use position is arranged to extend strake-flush with an outer contour 7 of the vehicle door 2, and which for actuation by an operator is arranged in an actuated position, in which the handle 4 protrudes relative to the outer contour 7 of the vehicle door 2 and can be actuated by the operator in order to open the vehicle door 2, a lever element 10, whose first lever end 11 is rotatably mounted on a lever rotational axis 12 mounted on the handle housing 8 and whose second lever end 14 is rotatably connected to a first longitudinal end 9 of the handle 4, and a lever mechanism 16, which is rotatably mounted on the handle housing 8 via a rotational axis 21, wherein a second longitudinal end 20 of the handle 4 is movably fastened to the handle housing 8 via the lever mechanism 16, wherein the lever element 10 is of a single-arm and angled configuration, wherein the lever mechanism 16 has a handle lever 22 and a lever body 23 rotatably mounted on the rotational axis 21, wherein the handle lever 22 is single-armed and angled, wherein a first end 24 of the handle lever 22 is rotatably connected to the second longitudinal end 20 of the handle 4 and a second end 25 of the handle lever 22 is rotatably connected to the lever body 23 via a pivot point 26, wherein the lever element 10 is movably coupled to the lever mechanism 16 in a manner that, during a movement of the handle 4 from the non-use position into the actuated position, the lever element 10 rotates around the lever rotational axis 12 and at the same time the lever mechanism 16 rotates around the rotational axis 21, and wherein the lever element 10 moves the first longitudinal end 9 of the handle 4 out of the outer contour 7, when the rotation around the rotational axis 12 of the lever begins, and the lever mechanism 16 moves the second longitudinal end 20 of the handle 4 out of the outer contour 7, when the rotation around the rotational axis 21 begins, only after a slack point 72 of the handle lever 22 has been exceeded.

According to aspects of the additional preferred embodiment, a motor-driven actuating element 19 is mounted on the handle housing 8, which rotates the lever element 10 around the lever rotational axis 12 in an electrically powered normal operation of the door handle assembly 3. The lever element 10 is movably coupled to the lever mechanism 16 via a movement transmission bracket 17. Further, the lever body 23 has a support element 71, against which the handle lever 22 abuts at least in portions in the non-use position of the handle 4 and during a movement of the handle 4 in the direction of the actuated position until the slack point 72 is exceeded.

According to additional aspects of the additional preferred embodiment, a first longitudinal end 39 of the movement transmission bracket 17 with a lever rotational axis distance 73 to the lever rotational axis 12 is rotatably connected to the lever element 10, and a second longitudinal end 40 of the movement transmission bracket 17 with a lever rotational axis distance 74 to the rotational axis 21 is rotatably connected to the lever mechanism 16. The lever body 23 has a single-armed passive lever 27 and a two-armed active lever 28, wherein a first end 29 of the first passive lever 27 and the active lever 28 are mounted on the rotational axis 21 mounted on the handle housing 8, wherein a first end 24 of the handle lever 22 is rotatably connected to the second longitudinal end 20 of the handle 4, wherein a second end 25 of the handle lever 22 is rotatably connected to a second end 31 of the passive lever 27, wherein a first active lever arm 28a of the active lever 28 is rotatably connected to the second longitudinal end 40 of the movement transmission bracket 17, and the support element 71 is formed on a second active lever arm 28b of the active lever 28. The first end 29 of the passive lever 27 is connected to the rotational axis 21 in a torque-proof manner and the first end 30 of the active lever 28 is rotatably connected to the rotational axis 21. The lever mechanism 16 has a holding element 33, wherein the passive lever 27 has an abutment portion 34 and a counter abutment portion 35 is formed on the active lever 28, and wherein the holding element 33 has a holding force pressing the abutment portion 34 of the passive lever 27 against the counter abutment portion 35 of the active lever 28.

According to additional aspects of the additional preferred embodiment, the holding element 33 allows the passive lever 27 to move relative to the active lever 28 against the holding force exerted by the holding element 33 so that the abutment portion 34 of the passive lever 27 is arranged spaced apart from the counter abutment portion 35 of the active lever 28. The holding element 33 is designed as an elastic spring element 36, with a first leg 36a of the spring element 36 engaging in a hook-shaped holding lug 37 formed on the passive lever 27 and a second leg 36b of the spring element 36 engaging in a hook-shaped holding piece 38 formed on the active lever 28. Further, the lever element 10 is of an U-shaped angled form, wherein a handle lever leg 44 ending at the first end 24 of the handle lever 22 is formed with a handle lever length 45 which is at least 1.25 times greater than a lever element length 46 of a lever element leg 47 ending at the second lever end 14 of the lever element 10. During a movement of the handle 4, the second lever end 14 of the lever element 10 is arranged at a constant spacing from the lever rotational axis 12, whereas the first end 24 of the handle lever 22 is arranged at a varying spacing from the rotational axis 21 depending on the movement position of the handle 4.

According to additional aspects of the additional preferred embodiment, the mechanical restoring element 49 pushes the handle 4 into its non-use position and allows a movement of the handle 4 from the non-use position in the direction of the actuated position against a restoring force generated by the mechanical restoring element 49. The mechanical restoring element 49 is formed as a return spring 50 which is wound around the lever rotational axis 12, wherein a first spring leg 50a of the return spring 50 is supported on the handle housing 8 and a second spring leg 50b of the return spring 50 is supported on the lever element 10.

An additional aspect of the additional preferred embodiment is a method of operating a door handle assembly 3 of a vehicle door 2, wherein the door handle assembly 3 has a handle housing 8 fastenable to the vehicle door 2 and a handle 4 mounted on the handle housing 8, which in a non-use position is arranged so as to extend strake-flush with an outer contour 7 of the vehicle door 2 and which, for actuation by an operator, is formed so as to be movable into an actuated position in which the handle 4 protrudes relative to the outer contour 7 of the vehicle door 2 and can be actuated by the operator to open the vehicle door 2, wherein the handle 4 is movably bound to the handle housing 8 with a first longitudinal end 9 via a lever element 10, and wherein the handle 4 is movably bound at a second longitudinal end 20 via a lever mechanism 16 to the handle housing 8, wherein during a movement from the non-use position into the actuated position the first longitudinal end 9 of the handle 4 is moved out of the outer contour 7 of the vehicle door 2 by the lever element 10 and the second longitudinal end 20 of the handle 4 is moved out with a time delay by the lever mechanism 16 to the first longitudinal end 9 of the handle 4, wherein the second longitudinal end 20 of the handle 4 is moved out further by the lever mechanism 16 than the first longitudinal end 9 of the handle 4.

An additional preferred embodiment of the invention relates to a door handle assembly 3 for a vehicle door 2 with a handle 4 extending in a non-use position strake-flush with an outer contour 7 of the vehicle door 2 for actuation by an operator, a handle housing 8, which can be fastened to the vehicle door 2, a lever element 10, which mounts the handle 4 on the handle housing 8, whose first lever end 11 is rotatably mounted on a lever rotational axis 12 mounted on the handle housing 8 and whose second lever end 14 is movably coupled to the handle 4, and a motor-driven actuating element 19 is movably coupled to the lever element 10, which is mounted on the handle housing 8 movably between a rest position via a handle extension position into a door opening position, wherein, in normal operation of the door handle assembly 3, the motor-driven actuating element 19 during its movement out of the rest position, in which the handle 4 is arranged in the non-use position, moves the handle 4 into the handle extension position into an actuated position, in which the handle 4 protrudes relative to the outer contour 7 of the vehicle door 2, wherein the handle 4 is formed to be movable out of the actuated position by means of actuation by an operator into a servo-opening position, wherein a detection means 77 is arranged on the handle housing 8, which is formed to effect a movement of the motor-driven actuating element 19 from the handle extension position into a door opening position upon detection of a movement of the handle 4 from the actuated position into the servo-opening position, wherein the motor-driven actuating element 19 is movably coupled to a vehicle door opening lever 18 movably mounted on the handle housing 8 between a standby position and an unlocking position, and wherein the motor-driven actuating element 19 during its movement from the handle extension position into the door opening position moves the vehicle door opening lever 18 from the standby position into the unlocking position into which the vehicle door 2 can be opened.

According to aspects of the additional preferred embodiment, the motor-driven actuating element 19 is rotatably mounted on the handle housing 8 via a motor drive axis 51, wherein, the movement of the motor-driven actuating element 19 from the rest position via the handle extension position into the door opening position is a rotational movement around the motor drive axis 51. The motor-driven actuating element 19 is discoidal with a non-uniform edge 52, which cooperates with a lever lug 10a formed on the lever element 10 when the actuating element 19 rotates around the motor drive axis 51 from the rest position into the handle extension position. The non-uniform edge 52 has a first edge portion 53 with a radius increasing from a minimum radius 54 to a maximum radius 55 and a second edge portion 56 with a maximum radius 55, wherein the maximum radius 55 is larger than the minimum radius 54. During a uniform rotational movement of the motor-driven actuating element 19 from the rest position into the handle extension position, the first edge portion 53 presses with increasing radius against the lever lug 10a of the lever element 10, wherein the handle 4 moves via the lever element 10 from the non-use position into the actuated position.

According to additional aspects of the additional preferred embodiment, the uniform rotational movement of the motor-driven actuating element 19 stops when the second edge portion 56 of the motor-driven actuating element 19 abuts on the lever lug 10a of the lever element 10. The non-uniform edge 52 has a third edge portion 57 with a minimum radius 54, wherein the transition from the second edge portion 56 to the third edge portion 57 is abruptly formed. The lever lug 10a of the lever element 10 abuts on the third edge portion 57 when the handle 4 is in the non-use position and the motor-driven actuating element 19 is in the rest position. An unlocking contour 59 is formed on the upper or lower side of the motor-driven actuating element 19 in the discoidal form, which interacts with the vehicle door opening lever 18 during a movement of the actuating element 19 from the handle extension position into the door opening position.

According to additional aspects of the additional preferred embodiment, the unlocking contour 59 has a first contour portion 60 with a constant neutral radius 61, a second contour portion 62 with a progression radius 63 and a third contour portion 64 with a constant radius 65, wherein the constant radius 65 is larger than the neutral radius 61, wherein the constant radius 65 and the neutral radius 61 each have a constant radius, and wherein the progression radius 63 is a radius increasing from the neutral radius 61 to the constant radius 65. During a rotational movement of the motor-driven actuating element 19 from the rest position to the handle extension position, the first contour portion 62 with neutral radius 61 tangentially moves past a longitudinal end 66 of the vehicle door opening lever 18. During a door unlocking rotational movement of the motor-driven actuating element 19 from the handle extension position into the door opening position, the second contour portion 62 and then the third contour portion 64 of the unlocking contour 59 press against the longitudinal end 66 of the vehicle door opening lever 18 and urge the vehicle door opening lever 18 from its standby position into its unlocking position for opening the vehicle door 2. The door unlocking rotational movement stops when the second edge portion 56 of the motor-driven actuating element 19 abuts on the lever lug 10a of the lever element 10. The constant radius 65 of the unlocking contour 59 is smaller than the maximum radius 55 of the non-uniform edge 52 of the motor-driven actuating element 19. Further, a cam disk in addition to and separately from the motor-driven actuating element 19 is rotatably mounted on the handle housing 8 via the motor drive axis 51, wherein the cam disk cooperates with the vehicle door opening lever 18 to move the vehicle door opening lever 18 from the standby position to the unlocking position.

Another preferred embodiment of the invention concerns a door handle assembly 3 for a vehicle door 2 with a handle housing 8 which can be fastened to the vehicle door 2, a handle 4 which is mounted on the handle housing 8 and which, in a non-use position, is arranged to extend strake-flush with an outer contour 7 of the vehicle door 2 and which, for actuation by an operator, is arranged in an actuated position, in which the handle 4 protrudes relative to the outer contour 7 of the vehicle door 2 and can be actuated by the operator to open the vehicle door 2, a lever element 10, whose first lever end 11 is rotatably mounted on a lever rotational axis 12 mounted on the handle housing 8 and whose second lever end 14 is rotatably connected to a first longitudinal end 9 of the handle 4, and a motor-driven actuating element 19 which rotates the lever element 10 around the lever rotational axis 12 and thereby moves the handle 4 from the non-use position into the actuated position, wherein a lever mechanism 16 is rotatably mounted on the handle housing 8 via a rotational axis 21, and wherein a second longitudinal end 20 of the handle 4 is movably fastened to the handle housing 8 via the lever mechanism 16.

According to aspects of the other preferred embodiment, a mechanical restoring element 49 pushes the handle 4 into its non-use position, allowing the movement of the handle 4 from the non-use position towards the actuated position against a restoring force generated by the mechanical restoring element 49. The mechanical restoring element 49 is formed as a return spring 50 which is wound around the lever rotational axis 12, wherein a first spring leg 50a of the return spring 50 is supported on the handle housing 8 and a second spring leg 50b of the return spring 50 is supported on the lever element 10. The lever element 10 is movably coupled to the lever mechanism 16 via a movement transmission bracket 17. A first longitudinal end 39 of the movement transmission bracket 17 is rotatably connected to the lever element 10 at a distance from the lever rotational axis 12, wherein a second longitudinal end 40 of the movement transmission bracket 17 is rotatably connected to the lever mechanism 16 at a distance from the rotational axis 21.

According to additional aspects of the other preferred embodiment, the lever mechanism 16 comprises a passive lever 27, an active lever 28 and a handle lever 22, wherein a first end 29 of the first passive lever 27 and a first end 30 of the active lever 28 are mounted on the rotational axis 21 mounted on the handle housing 8, wherein a first end 24 of the handle lever 22 is rotatably connected to the second longitudinal end 20 of the handle 4, wherein a second end 25 of the handle lever 22 is rotatably connected to a second end 31 of the passive lever 27, and wherein a connecting web 32 protrudes radially from the first end 30 of the active lever 28 and is rotatably connected to the second longitudinal end 40 of the movement transmission bracket 17. The first end 29 of the passive lever 27 is connected to the rotational axis 21 in a torque-proof manner, while the first end 30 of the active lever 28 is rotatably connected to the rotational axis 21. The lever mechanism 16 has a holding element 33, wherein the passive lever 27 has an abutment portion 34 and a counter abutment portion 35 is formed on the active lever 28, and wherein the holding element 33 has a holding force pressing the abutment portion 34 of the passive lever 27 against the counter abutment portion 35 of the active lever 28. The holding element 33 allows a movement of the passive lever 27 relative to the active lever 28 against the holding force exerted by the holding element 33, so that the abutment portion 34 of the passive lever 27 is spaced apart from the counter abutment portion 35 of the active lever 28.

According to additional aspects of the other preferred embodiment, the holding element 33 is formed as an elastic spring element 36, wherein a first leg 36a of the spring element 36 engages in a hook-shaped holding lug 37 formed on the passive lever 27 and a second leg 36b of the spring element 36 engages in a hook-shaped holding piece 38 formed on the active lever 28. The spring element 36 is arranged wound around the rotational axis 21. In the actuated position of the handle 4, the motor-driven actuating element 19 presses the second longitudinal end 40 of the movement transmission lever 17 at least in portions against a locking stop 67 fastened to the handle housing 8. Further, in the actuated position of the handle 4, the motor-driven actuating element 19 presses a support lug 68 formed on the lever element 10 at least in portions against a support stop 69 formed on the handle housing 8.

Another additional preferred embodiment of the invention concerns a door handle assembly 3 for a vehicle door 2 with a handle housing 8, which can be fastened to the vehicle door 2, a handle 4, which is mounted on the handle housing 8 and is arranged in a non-use position so as to extend strake-flush with an outer contour 7 of the vehicle door 2, and which is arranged in an actuated position for actuation by an operator, in which the handle 4 protrudes relative to the outer contour 7 of the vehicle door 2, and a vehicle door opening lever 18 movably mounted on the handle housing 8 between a standby position and an unlocking position opening the vehicle door 2, wherein the handle 4 is mounted to be movable by the operator from the actuated position into an emergency actuated position for a manual vehicle door opening, wherein the handle 4 is decoupled from the vehicle door opening lever 18 in its non-use position and in its actuated position, and wherein the handle 4 is coupled to the vehicle door opening lever 18 during a movement from the actuated position into the emergency actuated position and moves the same into the unlocked position.

According to additional aspects of the additional preferred embodiment, the lever mechanism 16 mounts the handle 4 rotatably on the handle housing 8, wherein the handle 4 is coupled to the vehicle door opening lever 18 during a movement from the actuated position into the emergency actuated position. The lever element 10 mounted on the handle housing 8 is connected to a first longitudinal end 9 of the handle 4, wherein the lever mechanism 16 has a passive lever 27, whose first end 29 is torque-proof connected to an rotational axis 21 rotatably mounted on the handle housing 8 and whose second end 31 is connected to a second longitudinal end 20 of the handle 4. The passive lever 27 has a radially extended actuating lug 75 at its first end 29, with a hook-shaped cam portion 76 formed on the vehicle door opening lever 18, and wherein during a movement of the handle 4 from the actuated position in the direction of the emergency actuated position, the actuating lug 75 engages in the cam portion 76 and urges the vehicle door opening lever 18 from the standby position into the unlocking position.

According to additional aspects of the other additional preferred embodiment, a counterforce element 78 is formed on a portion of the actuating lug 75 which allows movement of the handle 4 from the actuated position to the emergency actuated position against a counterforce exerted by the counterforce element 78. Further, the counterforce element 78 is formed as an elastic leg spring element 79, wherein a first leg 79a of the leg spring element 79 is supported on the actuating lug 75 and a second leg 79b of the leg spring element 79 abuts on a hook-shaped holding lug 80. The second leg 79b of the leg spring element 79 comes into contact with a limiting stop 81 formed on the handle housing 8 during a movement of the handle 4 from the actuated position in the direction of the emergency actuated position, wherein the leg spring element 79 is compressed in the emergency actuated position of the handle 4 to generate the counterforce.

The invention described above is, of course, not limited to the embodiment described and depicted. It is evident that the embodiment depicted in the drawing can be subject to numerous modifications which are obvious to the person skilled in the art according to the intended application, without leaving the scope of the invention. The invention includes everything that is contained in the description and/or depicted in the drawing, including anything that, deviating from the concrete example of design, is obvious to the person skilled in the art.

1. Door handle assembly for a vehicle door comprising:
a handle housing which can be fastened to the vehicle door,
a handle which is mounted on the handle housing and is arranged in a non-use position so as to extend strake-flush with an outer contour of the vehicle door and which, for actuation by an operator, is formed to be movable into an actuated position in which the handle protrudes relative to the outer contour of the vehicle door,
a lever element, wherein a first lever end is rotatably attached to a lever rotational axis, which is mounted on the handle housing, and wherein a second lever end is movably coupled to a first longitudinal end of the handle,
a motor-driven actuating element which rotates the lever element around the lever rotational axis in normal operation of the door handle assembly and thereby moves the handle from the non-use position into the actuated position, and
a lever mechanism which movably mounts a second longitudinal end of the handle on the handle housing,
wherein the first longitudinal end of the handle is rotatably mounted on the second lever end of the lever element,
wherein in an emergency operation of the door handle assembly in the case of a malfunction of the motor-driven actuating element, the handle is movable by the operator into an emergency handling position in which the first longitudinal end of the handle moves towards the handle housing relative to the non-use position and the second longitudinal end of the handle is arranged at a distance from the handle housing, and
wherein the lever mechanism includes a holding element which allows a movement of the first longitudinal end of the handle towards the handle housing and relative to the second lever end of the lever element, and a movement of the second longitudinal end of the handle away from the handle housing against a holding force exerted by the holding element.

2. Door handle assembly according to claim 1, wherein the lever mechanism has a passive lever, an active lever coupled to the motor-driven actuating element and a handle lever, wherein a first end of the first passive lever and a first end of the active lever are mounted on a rotational axis, which is mounted on the handle housing, wherein a first end of the handle lever is rotatably connected to the second longitudinal end of the handle and a second end of the handle lever is rotatably connected to a second end of the passive lever.

3. Door handle assembly according to claim 2, wherein the first end of the passive lever is connected in a torque-proof manner to the rotational axis and the first end of the active lever is rotatably connected to the rotational axis.

4. Door handle assembly according to claim 3, wherein the passive lever includes an abutment portion and a counter abutment portion is formed on the active lever, wherein in the non-use position of the handle the holding element presses the abutment portion of the passive lever against the counter abutment portion of the active lever.

5. Door handle assembly according to claim 4, wherein in the emergency handling position of the handle a compressive force exerted by an operator and exceeding the holding force of the holding element acts on the first longitudinal end of the handle and the abutment portion of the passive lever is arranged to be rotated away from the counter abutment portion of the active lever.

6. Door handle assembly according to claim 4, wherein during a movement from the non-use position into the emergency handling position, the handle transfers a compressive force exerted at the first longitudinal end by the operator via the second longitudinal end to the passive lever of the lever mechanism and effects a relative rotation of the passive lever with respect to the active lever, so that in the emergency handling position, the abutment portion of the passive lever is arranged at a distance from the counter abutment portion.

7. Door handle assembly according to claim 4, wherein the holding force of the holding element is dimensioned in a manner whereby the holding element presses the abutment portion of the passive lever against the counter abutment portion of the active lever at up to an acceleration force acting in the case of a vehicle accident or at up to a compression force of at least 30 g exerted by the operator.

8. Door handle assembly according to claim 2, wherein the holding element is formed as an elastic spring element, wherein a first leg (36a) of the spring element engages in a hook-shaped holding lug formed on the passive lever and a second leg (36b) of the spring element engages in a holding piece formed in a hook-shaped manner and on the active lever.

9. Door handle assembly according to claim 8, wherein the elastic spring element is wound around the rotational axis.

10. Door handle assembly according to claim 1, wherein the lever element includes, between its first lever end and its second lever end, a supporting lug which in the emergency handling position abuts on a movement limiting lug formed on the handle and limiting the movement of the handle in the direction of the handle housing.
